(19) United States
(12) Patent Application Publication
(10) Pub. No.: US 2008/0204495 A1
(43) Pub. Date: Aug. 28, 2008

(54) LIQUID EJECTING APPARATUS

(75) Inventors: Kohei UENO, Shiojiri-shi (JP); Kazuo SAITO, Shiojiri-shi (JP); Takashi AKAHANE, Nagano-ken (JP); Kazumasa HARADA, Matsumoto-shi (JP); Toshikazu KOTAKA, Shiojiri-shi (JP); Satoru WATANABE, Shioijiri-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 12/013,828

(22) Filed: Jan. 14, 2008

(30) Foreign Application Priority Data
Jan. 15, 2007 (JP) 2007-006012
Jan. 15, 2007 (JP) 2007-006023
Jun. 4, 2007 (JP) 2007-147737
Nov. 15, 2007 (JP) 2007-296356

(51) Int. Cl. B41J 29/38

(52) U.S. Cl. 347/14

(57) ABSTRACT

The invention provides a liquid ejecting apparatus that includes: a main scan section that scans the liquid ejecting head in a main scan direction; a sub scan section that scans the ejection target medium in a sub scan direction, the sub scan section including a pair of transport rollers and a pair of ejection rollers; and a controlling section that acquires, an expected timing of a switchover between a state in which the ejection target medium is nipped by both of the pair of transport rollers and the pair of ejection rollers and a state in which the ejection target medium is nipped by only one of the pair of transport rollers and the pair of ejection rollers, and that changes an ejecting condition, during a plurality of main scan operations in a transition interval that is set around the expected timing.

### BACKGROUND

1. Technical Field

The present invention relates to a liquid ejecting apparatus that ejects liquid onto a liquid ejection target medium. A non-limiting example of a liquid ejecting apparatus described in this specification is a recording apparatus such as a printer, a copier, a facsimile, and the like, which is provided with an ink-jet recording head and performs recording by discharging ink onto a recording target medium from the ink-jet recording head. In addition to such a recording apparatus, the liquid ejecting apparatus described in this specification encompasses a variety of apparatuses that ejects, in place of ink, liquid used in its specific application from a liquid ejecting head that corresponds to the ink-jet recording head onto a liquid ejection target medium that corresponds to the recording target medium so as to put the liquid onto the liquid ejection target medium.

2. Related Art

Examples of a liquid ejecting head used in a liquid ejecting apparatus according to the invention described below include, without any limitation thereto: a color material ejection head that is used in the production of a color filter for a liquid crystal display device or the like; an electrode material (i.e., conductive paste) ejection head that is used for electrode formation for an organic EL display device, a surface/plane emission display device (FED), and the like; a living organic material ejection head that is used for production of biochips; and a sample ejection head that functions as a high precision pipette, in addition to the recording head described above.

When an ink-jet printer that is an example of a liquid ejecting apparatus of the related art performs bidirectional printing by moving its recording head reciprocally in a main scan direction, in some cases, positional displacement between some dots that are formed in an outward movement of the recording head and other dots that are formed in a corresponding homeward movement thereof (i.e., disagreement in ink landing position therebetween) may be generated undesirably. In order to address such a problem, Japanese Patent No. 3,557,915 and JP-A-2005-22404 disclose a technique that corrects such displacement between dot positions. As another related art, JP-A-2004-230817 discloses a recording apparatus that performs recording by, at the front edge of a sheet of printing paper and the rear edge thereof, that is, at paper regions where the distance between the ink-discharging surface of a recording head thereof and a recording target surface tends not to be uniform, selectively using some nozzles that have distances falling within a predetermined range between the ink-discharging surface and the recording target surface.

As described in JP-A-2004-230817, these days, a type of ink-jet printers that is capable of performing so-called “marginless printing” is widely used. In the marginless printing, no margin is left along each of four sides of a sheet of printing paper. A sheet of recording paper is transported from an upstream side to a downstream side by a pair of paper transport rollers, which is provided at an upstream position when viewed from a recording head, and a pair of paper ejection rollers, which is provided at a downstream position when viewed therefrom. Having such a configuration, the marginless-printing-type ink-jet printers described above performs recording while transporting a sheet of printing paper by means of the pair of paper transport rollers only until the front edge of the printing paper reaches the pair of paper ejection rollers. On the other hand, the marginless printer performs recording while transporting the printing paper by means of the pair of paper ejection rollers only after the rear edge of the printing paper is released from the pair of paper transport rollers.

When a sheet of recording paper is “nipped” by both of the pair of paper transport rollers and the pair of paper ejection rollers, it is possible to transport the recording paper in such a manner that the recording paper is pressed against a paper transportation guide (i.e., platen) securely, which is provided at a position opposite the recording head. By this means, it is possible to keep a constant and even clearance between the recording head and the recording paper. In contrast, until the pair of paper ejection rollers nips the front edge of printing paper (i.e., during the execution of marginless printing onto the front region of the printing paper), and in addition thereto, after the pair of paper transportation rollers has released the rear edge of printing paper (i.e., during the execution of marginless printing onto the rear region of the printing paper), it is likely that a portion of the printing paper “becomes poised in space”, that is, comes away from the paper transport guide and thus raised toward the recording head. In addition, it is further likely that either the front edge of the printing paper or the rear edge thereof becomes closer to the head surface of the recording head so that the printing paper takes an undesirably inclined position.

FIG. 21 is a diagram that schematically illustrates an example of the above-described phenomenon where a portion of a sheet of printing paper gets poised in space when the rear edge of the printing paper is released from the pair of paper transport rollers. In FIG. 21, a reference numeral 4 denotes a pair of paper transport rollers. A reference numeral 18 denotes a paper-transport-master-driving roller whereas a reference numeral 19 denotes a paper-transport-slave-driven roller. In FIG. 21, a reference numeral 5 denotes a pair of paper ejection rollers. A reference numeral 25 denotes a paper-eject-master-driving roller whereas a reference numeral 26 denotes a paper-eject-slave-driven roller. A reference numeral 24 denotes an auxiliary roller. A reference numeral 23 denotes a recording head. Finally, a reference numeral 27 denotes a paper transport guide.

A reference numeral P denotes a sheet of recording paper that is nipped by the pair of paper transport rollers 4 (which is shown in a solid line). Since the recording paper is pressed against the paper transport guide 27 securely while the pair of paper transport rollers 4 nips the recording paper, it is unlikely that any portion of the recording paper gets poised in space. Upon the releasing of the rear edge of the recording paper from the pair of paper transport rollers 4, it is likely that the rear region of the recording paper (denoted as P′) comes away from the paper transport guide 27 as shown in an alternate long and two short dashes line. In addition thereto, it is further likely that the rear edge of the recording paper is raised toward the head surface of the recording head 23 so that the recording paper takes an undesirably inclined position.

As the recording paper takes a slanted (i.e., partially raised) position as illustrated in the drawing, there occurs unevenness in the distance between the recording paper and a plurality of ink discharging nozzles (#1-#k) that are arrayed along a sub scan direction, which differs from one nozzle to another. As a result thereof, displacement in dot positions is generated along a scan direction. FIGS. 22A, 22B, 22C, and 22D is a set of explanatory diagrams that illustrates displacement in dot positions. FIG. 22A shows a dot pattern that is formed while the pair of paper transport rollers 4 nips a sheet of printing paper.

FIG. 22B shows a dot pattern that is formed after the pair of paper transport rollers 4 has released the rear edge of printing paper. As illustrated in the drawing, the formed dot pattern is V-inclined. It should be particularly noted that dot-positional displacement with respect to (i.e., viewed from) a reference position, which is a dot position illustrated in FIG. 22A, is relatively conspicuous at upstream nozzles where the printing paper is raised at a greater degree (note that the #k nozzle is the most upstream one as shown in FIG. 21). This means that it is more likely that the degradation in the quality of formed dots is visually perceived at the upstream nozzles.

In order to avoid any significant degradation in the quality of formed dots, it is possible to conceive a method of shifting ink-discharge timing (i.e., correction of displacement in dot positions) so as to adjust the dot position corresponding to, for example, the center ink-discharging nozzle or the approximately central ink-discharging nozzle into the reference position described above. If so configured, as shown in FIG. 22C, it is possible to significantly reduce the amount of dot-positional displacement, especially, at the most upstream #k nozzle at which the amount of displacement reduction is the greatest among all ink-discharging nozzles.

A printer control unit is capable of obtaining information on the position of a sheet of recording paper on its transport channel on the basis of a detection signal that is supplied from a sensor provided on the transport channel. By this means, in a theoretical sense, the printer control unit knows the point in time at which the rear edge of the sheet of recording paper is released from the pair of paper transport rollers 4. However, due to a margin of error in the assembly of a recording apparatus, a margin of error in the dimension of recording paper, though not limited thereto, it is possible that the point in time at which the rear edge of the sheet of recording paper is actually released from the pair of paper transport rollers 4 is shifted from, and thus does not coincide with, the designed theoretical point in time at which the rear edge of the sheet of recording paper is supposed to be released from the pair of paper transport rollers 4.

In a case where such a disagreement between the actual release timing and the theoretical release timing occurs, for example, if the correction of dot-positional displacement described above is applied at a point in time at which the rear edge of the recording paper has not yet been released from the pair of paper transport rollers 4, displacement in dot positions occurs as a result of such an inappropriate application of the correction as illustrated in FIG. 22D, where it would be possible to obtain a desirable dot pattern without involving such dot-positional displacement as shown in FIG. 22A if the above-described inappropriate application of the correction were not made. As a consequence of the inappropriate correction described above, the quality of formed dots is degraded, which could be otherwise avoided.

The above-explained problem is most likely to occur at a point in time at which the rear edge of a sheet of recording paper is released from the pair of paper transport rollers 4 (i.e., during the execution of marginless printing onto the rear region of the printing paper). If the recording apparatus has a configuration in which the printing paper tends to be raised until the front edge of the recording paper reaches the pair of paper ejection rollers 5, the above-explained problem is also likely to occur during the execution of marginless printing onto the front region of the printing paper.

### SUMMARY

An advantage of some aspects of the invention is to provide an apparatus that is capable of significantly reducing any degradation in the quality of formed dots.

In order to address the above-identified problem without any limitation thereto, the invention provides, as a first aspect thereof, a liquid ejecting apparatus including: a liquid ejecting head that has liquid ejecting nozzles, the liquid ejecting nozzles forming dots on an ejection target medium by ejecting liquid onto the ejection target medium; a main scan section that scans the liquid ejecting head in a main scan direction; a sub scan section that scans the ejection target medium in a sub scan direction, the sub scan section including a pair of transport rollers and a pair of ejection rollers, the pair of transport rollers being provided at an upstream position with respect to the liquid ejecting head, the pair of ejection rollers being provided at a downstream position with respect to the liquid ejecting head; a detecting section that detects the position of the ejection target medium on a transport channel; and a controlling section that acquires, on the basis of information supplied from the detecting section, an expected timing of a switchover between a state in which the ejection target medium is nipped by both of the pair of transport rollers and the pair of ejection rollers and a state in which the ejection target medium is nipped by only one of the pair of transport rollers and the pair of ejection rollers, and that changes, during a plurality of main scan operations in a transition interval that is set around the expected timing, either the positions of the dots or the sizes of the dots with respect to the main scan direction stepwise.

With such a configuration, even when there is an error in the expected timing of a switchover between a state in which the ejection target medium is nipped by both of the pair of transport rollers and the pair of ejection rollers and a state in which the ejection target medium is nipped by only one of the pair of transport rollers and the pair of ejection rollers, which is acquired on the basis of information supplied from the detecting section, it is possible to avoid any substantial degradation in the quality of formed dots.

The term “the position of the ejection target medium on a transport channel (i.e., the position thereof in the sub scan direction)” means the front-edge position of the ejection target medium, the rear-edge position of the ejection target medium, or both of the front-edge position of the ejection target medium and the rear-edge position thereof. The controlling section may obtain information on the rear-edge position of the ejection target medium on the basis of information on the front-edge position of the ejection target medium that is supplied from the detecting section and information on the length of the ejection target medium.

### BRIEF DESCRIPTION OF THE DRAWINGS

The invention will be described with reference to the accompanying drawings, wherein like numbers reference like elements.

FIG. 1 is a side sectional view that schematically illustrates an example of the configuration of a printer, which is a non-limiting example of a liquid ejecting apparatus according to an embodiment of the invention.

FIG. 2 is a diagram that schematically illustrates an example of the nozzle array pattern of a recording head of a printer, which is a non-limiting example of a liquid ejecting apparatus according to an embodiment of the invention.

FIG. 3 is a block diagram that schematically illustrates an example of the configuration of a control unit provided in a printer, which is a non-limiting example of a liquid ejecting apparatus according to an embodiment of the invention.

FIG. 4A is a diagram (graph) that shows an example of a dot position displacement correction value for each of a plurality of nozzles, whereas FIG. 4B is a diagram that shows an example of a dot position displacement amount for each of the plurality of nozzles.

FIG. 5A is a diagram that shows an example of a dot position displacement correction value for each of a plurality of nozzle blocks, whereas FIG. 5B is a diagram that shows an example of a dot position displacement amount for each of the plurality of nozzle blocks.

FIG. 6A is a diagram that shows an example of dot position displacement amount, whereas FIG. 6B is a diagram that shows an example of a dot position displacement correction value.

FIGS. 7A and 7B is a set of diagrams that shows an example of dot position displacement amount.

FIG. 8A is a diagram that shows an example of a dot position displacement correction value, whereas FIG. 8B is a diagram that shows an example of dot position displacement amount.

FIGS. 9A and 9B is a set of diagrams that shows an example of dot position displacement amount.

FIG. 10A is a diagram that shows an example of a dot position displacement correction value, whereas FIG. 10B is a diagram that shows an example of dot position displacement amount.

FIG. 11A is a diagram that shows an example of a dot position displacement correction value, whereas FIG. 11B is a diagram that shows an example of dot position displacement amount.

FIG. 12A is a diagram that shows an example of a dot position displacement correction value, whereas FIG. 12B is a diagram that shows an example of dot position displacement amount.

FIG. 13A is a diagram that shows an example of a dot position displacement correction value, whereas FIG. 13B is a diagram that shows an example of dot position displacement amount.

FIG. 14A is a diagram that shows an example of a dot position displacement correction value, whereas FIG. 14B is a diagram that shows an example of dot position displacement amount.

FIG. 15A is a diagram that schematically illustrates an example of a change in the size of dots during a transition interval, whereas FIG. 15B is a diagram that schematically illustrates an example of a change in the mixture ratio of dot sizes during the transition interval.

FIG. 16 is a side sectional view that schematically illustrates an example of the configuration of a printer, which is a non-limiting example of a liquid ejecting apparatus according to another embodiment of the invention.

FIG. 17 is a block diagram that schematically illustrates an example of the configuration of a control unit provided in a printer, which is a non-limiting example of a liquid ejecting apparatus according to another embodiment of the invention.

FIG. 18 is a flowchart that illustrates an example of the procedures for setting dot position displacement correction values.

FIG. 19 is a table that shows an example of the conditions for setting the dot position displacement correction values.

FIG. 20 is a table that shows an example of correction values that are set on the basis of a paper transport channel, temperature/humidity conditions, and paper front/rear edge.

FIG. 21 is an explanatory diagram that schematically illustrates an example of a paper elevation phenomenon in which a portion of a sheet of printing paper becomes closer to the surface of a recording head.

FIGS. 22A, 22B, 22C, and 22D is a set of explanatory diagrams that illustrates few non-limiting examples of displacement in dot positions that occurs when bidirectional printing is performed.

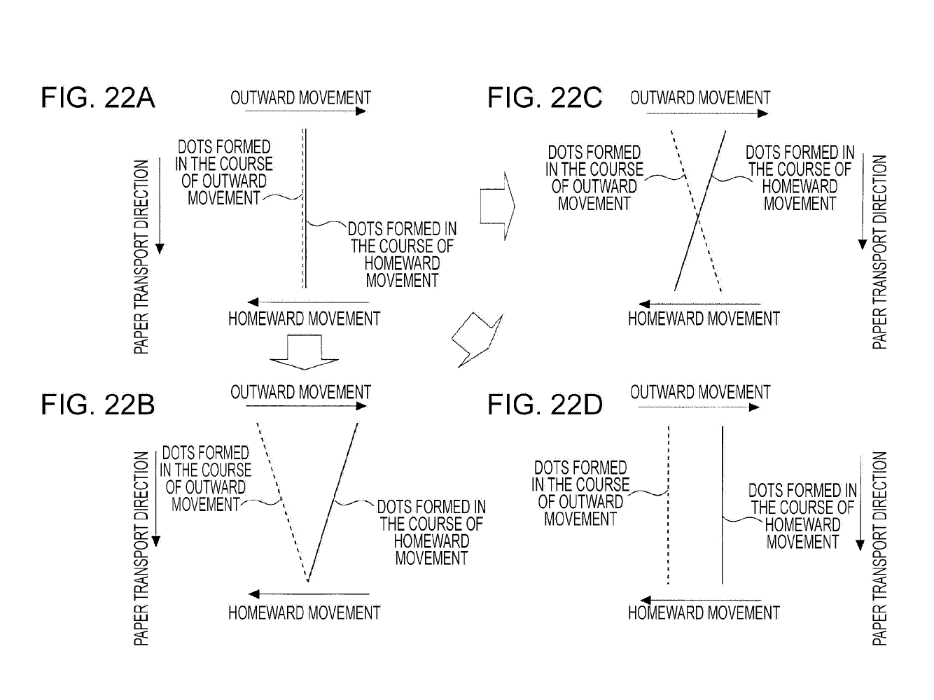

### DESCRIPTION OF EXEMPLARY EMBODIMENTS

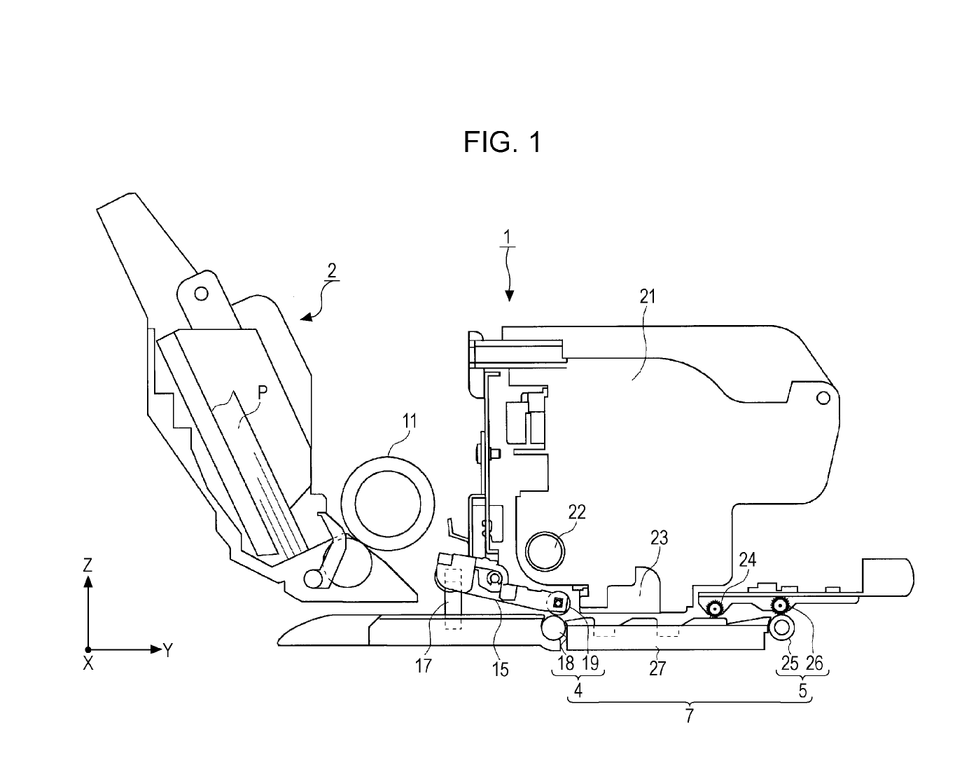

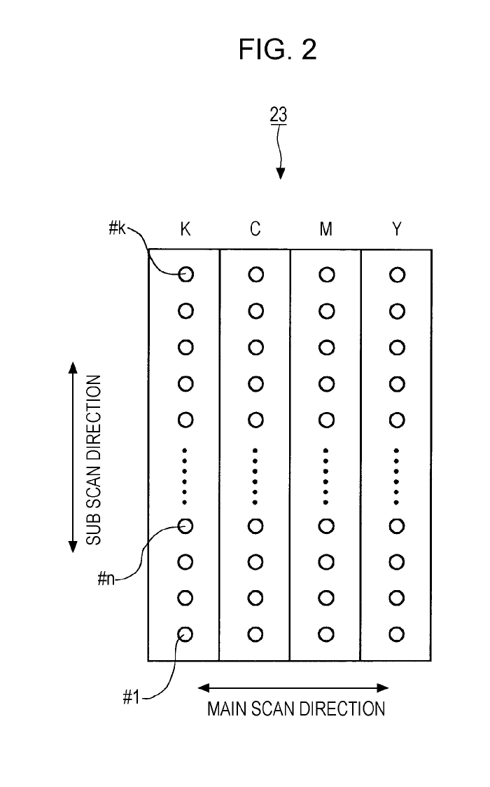

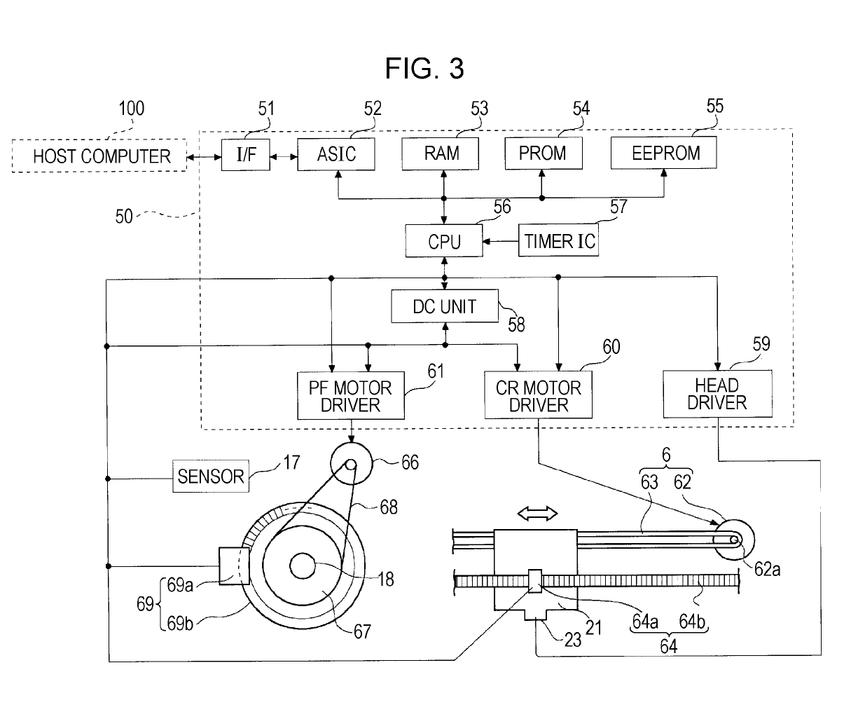

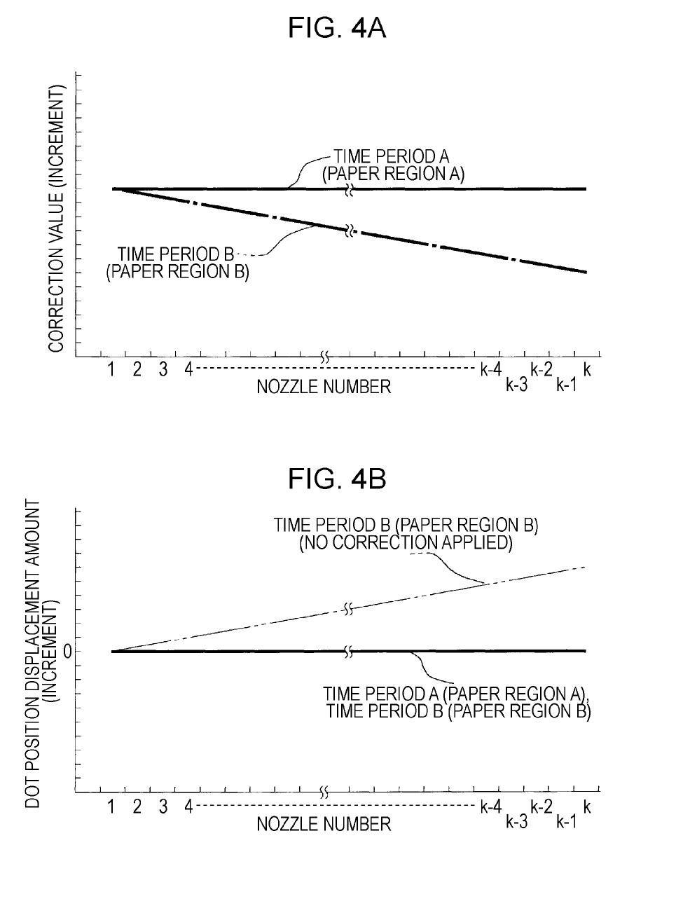

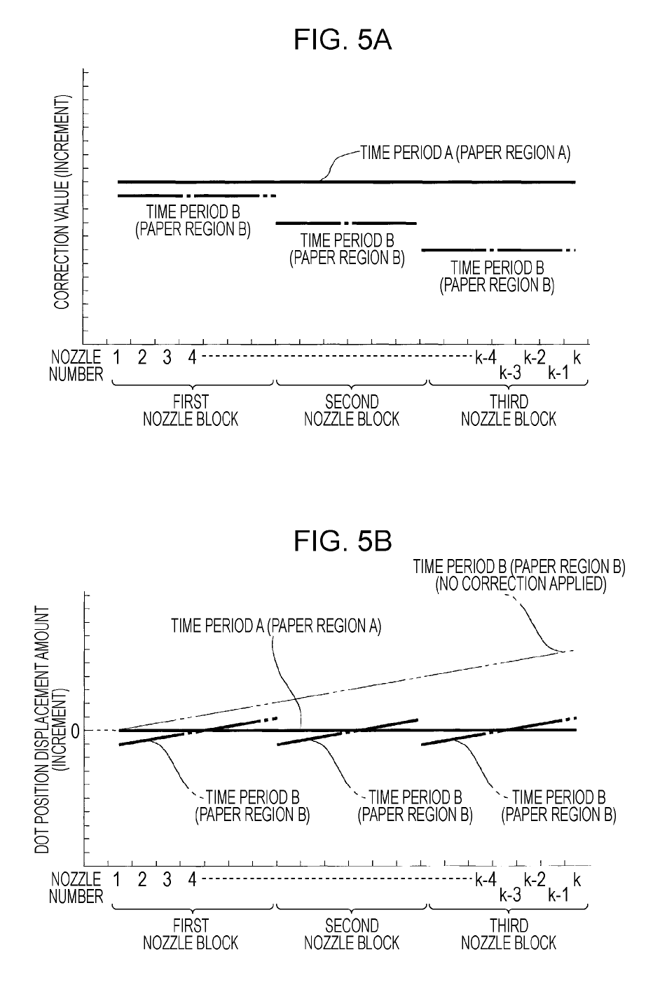

With reference to FIGS. 1-20, exemplary embodiments of the invention are described below. FIG. 1 is a side sectional view that schematically illustrates an example of the configuration of an ink-jet printer (hereafter simply referred to as “printer”) 1, which is a non-limiting example of a recording apparatus. In this context, the recording apparatus is an exemplary embodiment of a “liquid ejecting apparatus” according to the invention. FIG. 2 is a diagram that schematically illustrates an example of the nozzle array pattern of the recording head 23. FIG. 3 is a block diagram that illustrates an example of the configuration of a control unit 50, which is a non-limiting example of a controlling section according to the invention. FIG. 4A is a diagram (graph) that shows a dot-positional displacement correction value for each of a plurality of nozzles. FIG. 4B is a diagram that shows a dot-positional displacement amount for each of the plurality of nozzles. FIG. 5A is a diagram that shows a dot-positional displacement correction value for each of a plurality of nozzle blocks. FIG. 5B is a diagram that shows a dot-positional displacement amount for each of the plurality of nozzle blocks.

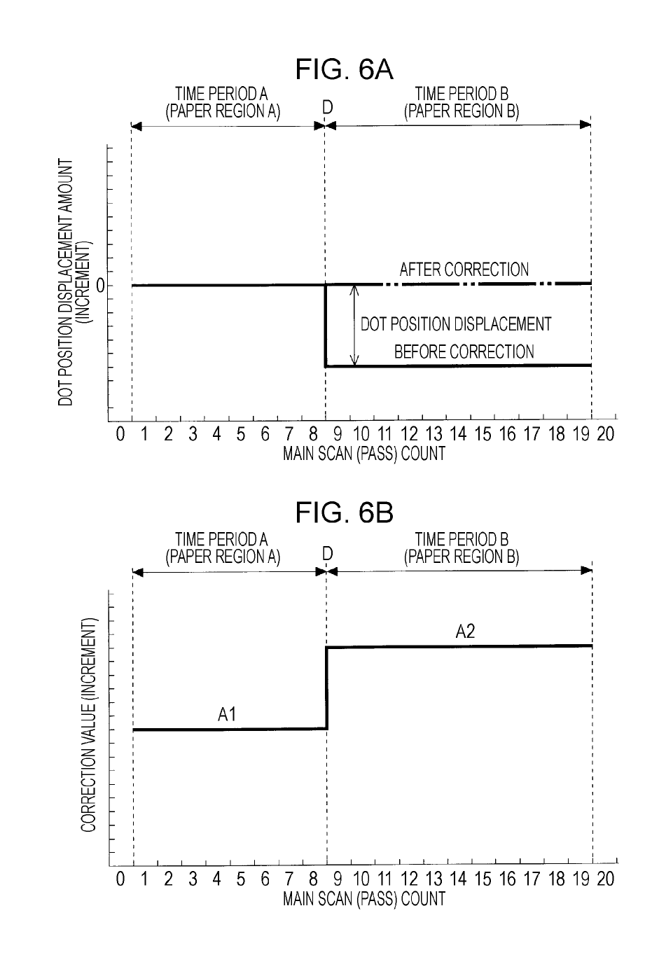

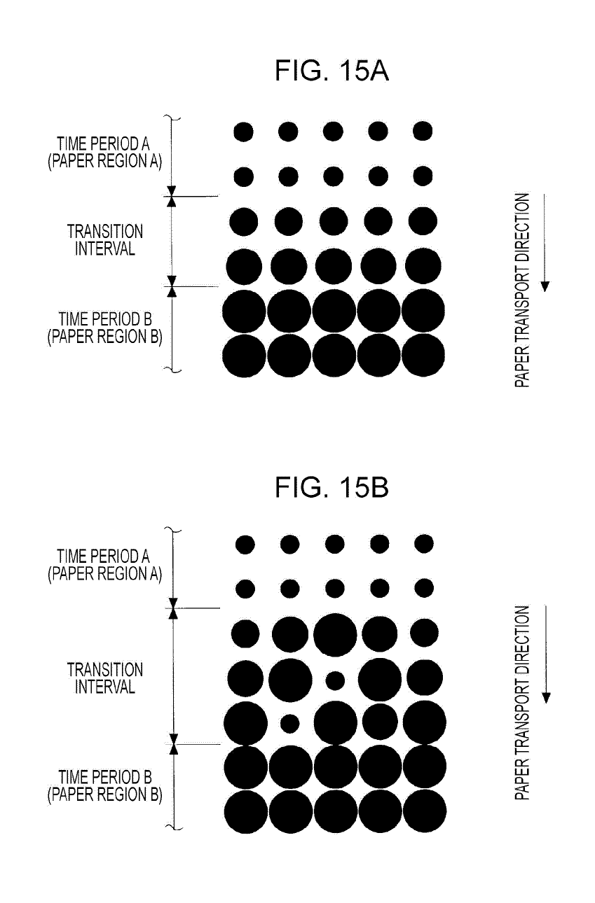

Each of FIGS. 6-14 is a diagram that illustrates either dot position displacement amounts or both of dot position displacement correction values and dot position displacement amounts. FIG. 15A is a diagram that schematically illustrates an example of a (graduated) change in the size of dots during a transition interval. FIG. 15B is a diagram that schematically illustrates an example of a change in the mixture ratio of dot sizes during the transition interval.

In the following description, the configuration of the printer 1 is explained while referring to FIGS. 1-3. It should be noted that, in the explanation given below, the right side of FIG. 1, that is, the front of the printer 1, is referred to as the “downstream side” of the paper transport channel of the printer 1, whereas the left side thereof is referred to as the “upstream side” of the paper transport channel of the printer 1.

The printer 1 has a rear paper-feed device 2, which is provided at the rear portion thereof. A user can place sheets of recording paper (which are, mainly, cut paper or single-sheet paper, and hereafter simply referred to as “paper”) P in a slanted position on the rear paper-feed device 2. The paper P is a non-limiting example of an “ejection target medium” according to the invention. The paper P is fed from the rear paper-feed device 2 to the pair of paper transport rollers 4, which is provided at the downstream thereof. The paper P, which has been fed by the rear paper-feed device 2, receives a paper-feeding force (i.e., paper transport force) from either the pair of paper transport rollers 4 or the pair of paper ejection rollers 5, or from both of the pair of paper transport rollers 4 and the pair of paper ejection rollers 5, so as to be transported toward the downstream side (i.e., sub-scanned). In the course of sub-scan transport thereof, the recording head 23, which is a non-limiting example of a liquid ejecting head according to the invention that discharges (i.e., ejects), for example, ink, which is a non-limiting example of liquid according to the invention, performs recording thereon. After being subjected to recording performed by the recording head 23 as described above, the pair of paper ejection rollers 5, which is provided at the downstream thereof, ejects the recorded paper P to the front of the printer 1.

In the following description, the operation and configuration of the printer 1 is explained in further detail. The rear paper-feed device 2 is provided with a paper-feed roller 11, which is rotated when driven by a driving motor, which is not illustrated in the drawing. The control unit 50 (refer to FIG. 3) controls the driving motor. After the paper-feed roller 11 has fed the paper P toward the downstream side, the pair of paper transport rollers 4 nips the paper P.

A sensor 17 is provided at an upstream position with respect to the pair of paper transport rollers 4. The sensor 17 detects the passage of the front edge of the paper P and the rear edge thereof. The control unit 50 (which will be described in detail later) of the printer 1 is capable of obtaining information on the position of the paper P (specifically, the position of the front edge of the paper P and the position of the rear edge thereof) on the paper transport channel (along a sub-scan direction) on the basis of a detection signal supplied from the sensor 17 and the respective rotational drive amounts of the paper-feed roller 11, the paper-transport-master-driving roller 18, and the paper-eject-master-driving roller 25. As a modification example of the configuration described above, information on the position of the rear edge of the paper P may be obtained on the basis of information on the position of the front edge thereof and information on the paper size of the paper P. The control unit 50 receives the paper size information from a printer driver.

The sensor 17 may be configured as an optical sensor that detects the passage of either the front edge of the paper P or the rear edge thereof on the basis of, for example, a change in the optical intensity of reflected light. Or alternatively, the sensor 17 may be configured as a mechanical sensor that detects the passage of either the front edge of the paper P or the rear edge thereof on the basis of a mechanical contact with the paper P. Note that specific examples described herein do in no case limit the configuration of the sensor 17.

The pair of paper transport rollers 4 is made up of the paper-transport-master-driving roller 18 and the paper-transport-slave-driven roller 19. A PF motor 66 (refer to FIG. 3) rotates the paper-transport-master-driving roller 18. The paper-transport-slave-driven roller 19, which is pressed against the paper-transport-master-driving roller 18, follows the rotation of the paper-transport-master-driving roller 18 as a slave roller. The paper-transport-master-driving roller 18 is configured as an axial member that extends along the width of the paper P. On the other hand, the paper-transport-slave-driven roller 19 is supported on the paper transport guide 15 in such a manner that the paper-transport-slave-driven roller 19 can rotate freely thereon. An urging member that is not shown in the drawing applies an urging force onto the paper-transport-slave-driven roller 19 toward the paper-transport-master-driving roller 18.

A paper-guide front member 27 is provided at a position opposite the recording head 23. The paper-guide front member 27 defines the distance between the paper P and the head surface of the recording head 23. The recording head 23 is provided at the bottom portion of a carriage 21. A user can mount four-color ink cartridges (not shown in the drawing) that are made up of, for example, a black (K) ink cartridge, a cyan (C) ink cartridge, a magenta (M) ink cartridge, and a yellow (Y) ink cartridge onto the carriage 21. Driven by a CR motor 62 (refer to FIG. 3), the carriage 21 reciprocates (i.e., moves in an outward direction and a homeward direction alternately) while being guided along a carriage guide axis 22 in the main scan direction, that is, in a direction perpendicular to the sheet face of FIG. 1.

While the carriage 21 reciprocates in the main scan direction, the recording head 23 discharges (i.e., ejects) ink of each color component under driving control. In this way, recording on the paper P is carried out. As illustrated in FIG. 2, the recording head 23 has a plurality of nozzles #1-#k that are arrayed in a line with an equal interval each between two adjacent nozzles along the sub scan direction for each of the ink color components C, M, Y, and K. Herein, it should be noted that the #1 nozzle is the most downstream one in each of the nozzle lines and that “k” is an integer. Upon reception of a driving signal that is supplied from the head driver 59 (refer to FIG. 3), each of the nozzles discharges ink, which is a non-limiting example of liquid according to the invention. The discharge timing and the discharge amount (i.e., the size of dots to be formed) thereof are adjustable by means of the driving signal.

Referring back to FIG. 1, after the completion of recording performed by the recording head 23, the pair of paper ejection rollers 5, which is made up of the paper-eject-master-driving roller 25 that is rotated under a driving force applied thereto and the paper-eject-slave-driven roller that is in contact with the paper-eject-master-driving roller 25 and follows the rotation thereof so as to rotate as a slave roller, ejects the paper P onto a stacker (not shown in the drawing) that is provided at the front portion of (or in front of) the printer 1. The reference numeral 24 denotes an auxiliary roller that functions to prevent the paper P from coming away from the paper-guide front member 27.

In the context of this specification, the printer 1 is configured so that it can perform so-called marginless printing. In the marginless printing, the printer 1 performs recording with no marginal space being left as blank at the top-edge region and the bottom-edge region of the paper P. When the printer 1 performs marginless printing at the top-edge region of the paper P, since the top edge of the paper P has not yet reached the pair of paper ejection rollers 5, the paper P receives a paper-feeding force from the pair of paper transport rollers 4 only. Next, after the top edge of the paper P has reached the pair of paper ejection rollers 5, the paper P receives a paper-feeding force both from the pair of paper transport rollers 4 and the pair of paper ejection rollers 5. After the bottom edge of the paper P has been released from the pair of paper transport rollers 4, the paper P receives a paper-feeding force from the pair of paper ejection rollers 5 only. As described above, in the marginless printing, a transport roller(s) that either dominantly or exclusively determines the precision in the feeding of the paper P is switched over from one to another depending on the position of the paper P on the paper transport channel. As understood from the explanation given above, the pair of paper transport rollers 4 and the pair of paper ejection rollers 5 make up a sub scan unit 7, which transports the paper P in the sub scan direction.

Next, with reference to FIG. 3, an explanation is given below of the configuration of the control unit 50, which performs various kinds of control in the printer 1. The control unit 50 is provided with an I/F 51, an ASIC 52, a RAM 53, a PROM 54, an EEPROM 55, a CPU 56, a timer IC 57, a DC unit 58, a paper-feed motor driver (hereafter abbreviated as “PF” motor driver) 61, a carriage motor driver (hereafter abbreviated as “CR” motor driver) 60, and a head driver 59. The I/F 51 functions as an interface that transmits/receives data to/from a host computer 100, which provides recording data and other information to the printer 1.

The CPU 56 performs arithmetic processing so as to execute a control program(s) of the printer 1. In addition, the CPU 56 performs other arithmetic processing required for operation thereof. The timer IC 57 generates a periodic interruption signal that is necessary for the CPU 56 to perform various kinds of processing. On the basis of recording data that is sent from the host computer 100 via the I/F 51, the ASIC 52 controls the resolution of recording, the waveform of a driving signal supplied to the recording head 23, though not limited thereto. The RAM 53 is used as a work area for the ASIC 52 and the CPU 56 and also as a temporary storage area for other data. The PROM 54 and the EEPROM 55 store a variety of control programs (firmware) that is required for controlling the printer 1, data necessary for processing, and the like.

The DC unit 58 is a control circuit that controls the rotational speed of DC motors, that is, the CR motor 62 and the PF motor 66. The DC unit 58 has a PID control unit, an acceleration control unit, a PWM control circuit, and the like, which are not shown in the drawing. On the basis of a control command sent from the CPU 56 and output signals sent from sensors (corresponding to a detecting section according to the invention) such as a rotary encoder 69, a linear encoder 64, and the like, the DC unit 58 performs various kinds of arithmetic processing so as to control the rotational speed of the DC motors. Then, the DC unit 58 outputs a control signal to each of the CR motor driver 60 and the PF motor driver 61.

Under the control of the DC unit 58, the PF motor driver 61 drives and controls the PF motor 66. The PF motor 66 rotates a plurality of driving target objects, which are the paper-transport-master-driving roller 18 and the paper-eject-master-driving roller 25 according to the present embodiment of the invention. A reference numeral 68 denotes an endless belt. A reference numeral 67 denotes a slave-driven pulley that is mounted at the axial end of the paper-transport-master-driving roller 18. A motive power transmission mechanism, which is not shown in the drawing, transmits (i.e., communicates) motive power from the paper-transport-master-driving roller 18 to the paper-eject-master-driving roller 25.

Under the control of the DC unit 58, the CR motor driver 60 drives and controls the CR motor 62 so as to reciprocate the carriage 21 in the main scan direction or to stop/hold the carriage 21. Under the control of the CPU 56, the head driver 59 drives and controls the recording head 23 in accordance with the recording data sent from the host computer 100. A reference numeral 63 denotes an endless belt, one side of which is wound around a driving pulley 62a that is mounted on the rotational axis of the CR motor 62. The other side of the endless belt 63 is wound around a driven pulley that is not shown in the drawing. In other words, the endless belt 63 is stretched between the driving pulley 62a and the driven pulley in a rotational manner. The carriage 21 is fixed to a portion of the endless belt 63. The structure that operates the carriage 21 in the main scan direction as described above constitutes a main scan unit 6, which reciprocates the recording head 23 in the main scan direction.

A signal outputted from the rotary encoder 69 that is used for detecting the rotation amount, the rotation direction, and the rotation speed of the paper-transport-master-driving roller 18 (PF motor 66) is inputted into the CPU 56 and the DC unit 58. In addition, a signal outputted from the linear encoder 64 that is used for detecting the absolute position of the carriage 21 in the main scan direction is also inputted into the CPU 56 and the DC unit 58.

The rotary encoder 69 has a detection unit 69a and a disc-shaped scale 69b. The disc-shaped scale 69b has a number of translucent portions at its disc circumference. The detection unit 69a has a light emission portion that emits light toward the translucent portions and further has a light reception portion that receives light that has transmitted through the translucent portions. Having such a configuration, the detection unit 69a outputs a rising signal and a falling signal that are formed by light that transmits through the translucent portions as the disc-shaped scale 69b rotates. On the basis of the output signal coming from the rotary encoder 69, the control unit 50 calculates the rotation amount, the rotation speed, and the rotation direction of the paper-transport-master-driving roller 18 and the paper-eject-master-driving roller 25. By this means, the control unit 50 performs paper-feed control on the target paper P.

The linear encoder 64 has a detection unit 64a and a code plate 64b. The code plate 64b has an elongated shape that extends in the main scan direction. The detection unit 64a has a light emission portion that emits light toward a plurality of translucent portions arrayed on the code plate 64b along the main scan direction. The detection unit 64a further has a light reception portion that receives light that has transmitted through the translucent portions. The detection unit 64a outputs a rising signal and a falling signal that are formed by light that transmits through the translucent portions. On the basis of the output signal that has been received from the detection unit 64a, the control unit 50 calculates the position and speed of the carriage 21 moving along the main scan direction.

The printer 1 has a configuration described above. Next, with reference to FIGS. 4 and 5, an explanation is given below as to how displacement in dot positions is corrected. In the following description, a paper-regional or time-axial segment in which recording is performed while the pair of paper transport rollers 4 nips the paper P (i.e., a partial area of the paper P or a partial window on a time axis where the printer 1 performs recording while the pair of paper transport rollers 4 nips the paper P) is referred to as “segment A”. In the accompanying drawings, this is referred to as “time period A (paper region A)” although it signifies the same concept as the segment A described above. On the other hand, another paper-regional or time-axial segment in which recording is performed while the pair of paper ejection rollers 5 only transports the paper P after the pair of paper transport rollers 4 has released the paper P (i.e., another partial area of the paper P or another partial window on a time axis where the printer 1 performs recording while the pair of paper ejection rollers 5 only transports the paper P after the pair of paper transport rollers 4 has released the paper P) is referred to as “segment B”. In the accompanying drawings, this is referred to as “time period B (paper region B)” although it signifies the same concept as the segment B described above.

In the production process of the printer 1, a correction value used for correcting displacement in dot positions is determined on the basis of, for example, dot position displacement that occurs in the segment A; and then, a predetermined correction value is pre-stored in a memory means of the control unit 50 (e.g., PROM 54) if it is necessary to apply correction thereto, whereas a correction value of zero (in an increment value) is pre-stored in the memory means of the control unit 50 if it is not necessary to apply correction thereto.

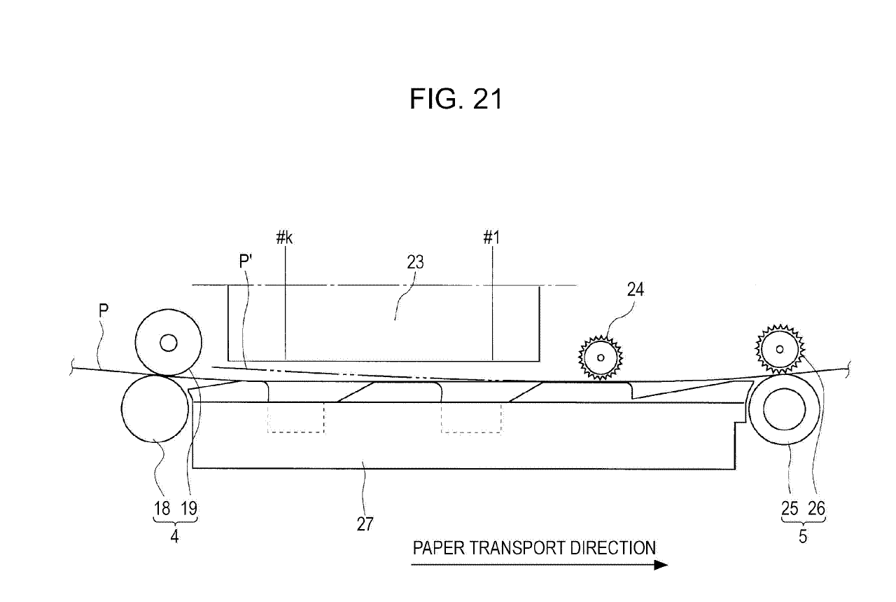

FIG. 4A is a diagram that illustrates a correction value that is used for correcting dot position displacement in each of nozzles numbered from 1 to k. As has already been described above while making reference to FIG. 21, the distance between a plurality of nozzles and the paper P is substantially uniform in the segment A. Therefore, the same single correction value is used in the segment A for the plurality of nozzles. Notwithstanding the foregoing, correction values that differ from one nozzle to another may be used if, in the segment A, there occurs unevenness in the distance between the plurality of nozzles and the paper P.

Next, as illustrated in FIG. 4, after recording has transitioned into the segment B, a correction value that is individually adjusted for each of the plurality of nozzles is applied depending on the position of the individual nozzle in the sub scan direction, which corresponds to the horizontal position thereof in FIG. 4. In other words, each of the plurality of nozzles has a unique correction value that is to be applied in the segment B. In an example illustrated in FIG. 4, the same single correction value is applied to the most downstream nozzle #1 in the segments A and B because the amount of dot position displacement does not almost change at the point of transition (i.e., switchover) from the segment A into the segment B. On the other hand, since the paper P tends to be raised at the greatest degree at the most upstream nozzle #k as shown in FIG. 21, a difference between a correction value that is applied in the segment A and another correction value that is applied in the segment B at the most upstream nozzle #k is set to be the largest. As described above, the amount of change in correction values at the point of transition from the segment A into the segment B, in other words, a difference between a correction value that is applied in the segment A and another correction value that is applied in the segment B, is set to be larger as the nozzle number approaches the most upstream one, that is, #k.

Note that it is possible to implement the correction of dot-positional displacement as described above by, for example, shifting ink discharge timing with respect to the traveling position (i.e., scan position) of the carriage 21. It should be further noted that it is possible to apply an individual correction value described above for each of the plurality of nozzles by, for example, providing a delay circuit for each nozzle. With such a configuration, delay time can be individually adjusted for each nozzle, which is applied when a driving signal is inputted so as to trigger the discharging of ink, thereby making it possible to apply the individual correction on a nozzle-by-nozzle basis.

By this means, even if the paper P becomes partially raised and thus inclined with respect to the head surface of the recording head 23 as a transport status thereof transitions from the segment A into the segment B, there occurs almost no change in the amount of dot position displacement as shown in FIG. 4B, which means that it is possible to keep a desirable state that is free from displacement in dot positions. Therefore, it is possible to avoid any substantial degradation in the quality of formed dots after entering the segment B.

In the non-limiting example illustrated in FIG. 4A, correction values have linearity, or in other words, form a straight line as illustrated therein because the amount of change (incremental change amount) in the correction values is assumed to be constant with respect to, and thus proportional to, an increment in nozzle numbers within the segment B. This linearity corresponds to the fact that, as illustrated in an alternate long and two short dashes line in FIG. 4B, which shows a case where no correction is applied, a change in dot position displacement amount is assumed to be constant with respect to an increment in the nozzle numbers. Therefore, if the change in dot position displacement amount is not constant with respect to an increment in the nozzle numbers, it is preferable to adjust the amount of change in the correction values so as to correspond to such an inconstant change in dot position displacement amount.

In the configuration of the printer 1 according to the present embodiment of the invention described above, each of the plurality of nozzles has a unique correction value. However, the invention is not limited to such an exemplary configuration. For example, as a modification thereof, it may be configured so that each of the plurality of nozzle blocks has a unique correction value. In such a modification example, each of the plurality of nozzle blocks is made up of a plurality of nozzles. FIG. 5A illustrates such a modified embodiment of the invention. Although the printer 1 according to the modified embodiment of the invention mentioned herein has three nozzle blocks, the number of the nozzle blocks is in no case limited to three. In each of the first, second, and third nozzle blocks, a correction value is set with the center nozzle being chosen as a reference target for correction among the plurality of nozzles therein. Therefore, at the center nozzle, the amount of displacement in dot positions in the segment B is substantially equal to the amount of displacement in dot positions in the segment A in each of the first, second, and third nozzle blocks as illustrated in FIG. 5B, which means that the dot position displacement amount is substantially zero at the center nozzle therein. On the other hand, minor amount of dot position displacement occurs at both ends in each of the first, second, and third nozzle blocks.

Although minor dot-positional displacement occurs at both ends in each of the first, second, and third nozzle blocks as described above, the amount of displacement thereof is substantially smaller in comparison with the amount of displacement in dot positions that will be observed in a case where no correction is applied, which is shown in an alternate long and two short dashes line in FIG. 5B. Thus, the modified embodiment of the invention described above makes it possible to avoid any substantial degradation in the quality of dots formed in the segment B. In addition thereto, as an advantage of the modified embodiment of the invention described above, control processing that is required for management of correction values and application thereof is simplified because they are managed and applied for each nozzle block as a group.

In the examples described above, a paper-regional or time-axial segment in which recording is performed while the pair of paper transport rollers 4 nips the paper P, that is, a partial area of the paper P or a partial window on a time axis where the printer 1 performs recording while the pair of paper transport rollers 4 nips the paper P, is referred to as “segment A”. On the other hand, in the foregoing examples, another paper-regional or time-axial segment in which recording is performed while the pair of paper ejection rollers 5 only transports the paper P after the pair of paper transport rollers 4 has released the paper P, that is, another partial area of the paper P or another partial window on a time axis where the printer 1 performs recording while the pair of paper ejection rollers 5 only transports the paper P after the pair of paper transport rollers 4 has released the paper P, is referred to as “segment B”. As a modification example of such a definition, the above-described segment A may be divided into two sub-segments. Specifically, the segment A may be made up of a paper-regional or time-axial “sub-segment A_1” where the front edge of the paper P has not yet reached the pair of paper ejection rollers 5 and another paper-regional or time-axial “sub-segment A_2” where the front edge of the paper P has already reached the pair of paper ejection rollers 5. In such a modification example, correction values are adjusted differentially between the sub-segment A_1 and the sub-segment A_2. In such a modified configuration, the sub-segment A_1 is more susceptible to the problem of an uneven distance between each of the nozzles and the paper P in comparison with the sub-segment A_2. In order to provide a solution thereto, each of the plurality of nozzles has a unique correction value that is to be applied in the sub-segment A_1 as done so in the segment B. By this means, it is possible to enhance dot formation quality.

Next, while referring to FIGS. 6-14, an explanation is given below of a means for avoiding any substantial degradation in the quality of formed dots that is caused by a shift in a point in time (i.e., timing shift) at which the rear edge of the paper P is actually released from the pair of paper transport rollers 4. In the following description, a technique for effectively avoiding any substantial degradation in dot formation quality that is caused when the rear edge of the paper P becomes released from the pair of paper transport rollers 4 is disclosed as an embodiment of the invention. As understood from the explanation given below, this aspect of the invention is also applicable to the prevention of any substantial degradation in dot formation quality that is caused when the front edge of the paper P becomes nipped by the pair of paper ejection rollers 5.

FIG. 6A illustrates a dot position displacement amount along the main scan direction in the center nozzle among the plurality of nozzles #1-#k of the recording head 23. In FIG. 6A, a solid line represents a dot position displacement amount before correction. An alternate long and two short dashes line in FIG. 6A represents a dot position displacement amount after correction.

The reference numeral D denotes a theoretical timing (i.e., designed timing) that is recognized by the control unit 50 as a point in time at which the rear edge of the paper P is supposed to be released from the pair of the paper transport rollers 4. In a specific example illustrated in FIG. 6A, the pair of paper transport rollers 4 continuously nips the paper P up to the eighth execution of the main scan operation, whereas the paper P is released from the pair of paper transport rollers 4 and then transported under a paper-feeding force applied solely from the pair of paper ejection rollers 5 at the ninth and subsequent executions of the main scan operation. However, in the actual implementation of the invention, the theoretical point in time D could be shifted from the illustrated position due to a margin of error in the assembly of the printer 1, a margin of error in the dimension of recording paper, though not limited thereto.

Unless dot-positional displacement correction values are switched over as a transport status transitions from the segment A into the segment B, as shown in a solid line in FIG. 6A, the problem of dot position displacement arises because the distance between the paper P and the recording head 23 changes at the point of transition into the segment B. In order to provide a solution thereto, as illustrated in FIG. 6B, a correction value A2 in place of a correction value A1 is applied in the segment B. Herein, the correction value A2 is obtained as a result of addition of a change amount (i.e., a correction value equivalent to dot position displacement amount) to the correction value A1, which is used for correcting dot position displacement in the segment A. As the correction value A2 is applied in the segment B, displacement in dot positions is corrected as shown in an alternate long and two short dashes line in FIG. 6A. In the foregoing exemplary embodiment of the invention that is explained above while referring to FIG. 4, such correction is applied for each of the plurality of nozzles. In like manner, in the foregoing exemplary embodiment of the invention that is explained above while referring to FIG. 5, such correction is applied for each of the plurality of nozzle blocks.

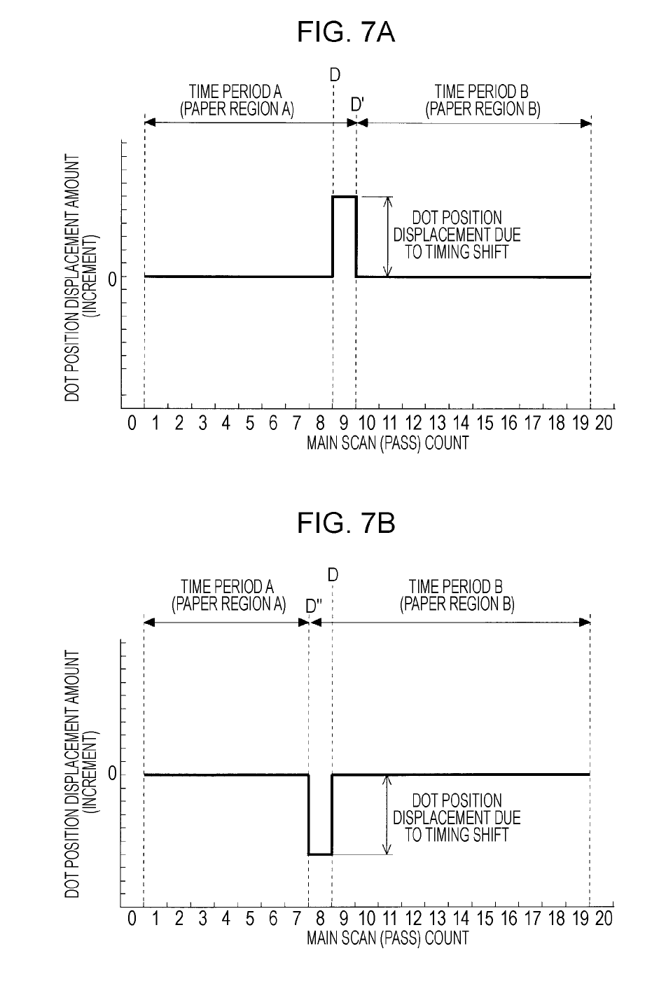

It is assumed here that the actual point in time at which the rear edge of the printing paper P is released from the pair of paper transport rollers 4 is shifted into a timing that is later than the theoretical release point in time that is recognized by the control unit 50. For example, it is assumed here that the actual release timing D′ is delayed with respect to the theoretical release timing D as illustrated in FIG. 7A (i.e., the actual release timing D′ is after the theoretical release timing D). In such a case, the correction value A2 is inappropriately applied to the ninth execution of the main scan operation whereas the correction value A1 should be applied thereto. As a result of such a misapplication of the correction value, a substantially large displacement in dot positions occurs.

On the other hand, it is assumed here that the actual point in time at which the rear edge of the printing paper P is released from the pair of paper transport rollers 4 is shifted into a timing that is earlier than the theoretical release point in time that is recognized by the control unit 50. For example, it is assumed here that the actual release timing D″ is forwarded with respect to the theoretical release timing D as illustrated in FIG. 7B (i.e., the actual release timing D″ is before the theoretical release timing D). In such a case, the correction value A1 is inappropriately applied to the eighth execution of the main scan operation whereas the correction value A2 should be applied thereto. As a result of such a misapplication of the correction value, a substantially large displacement in dot positions occurs.

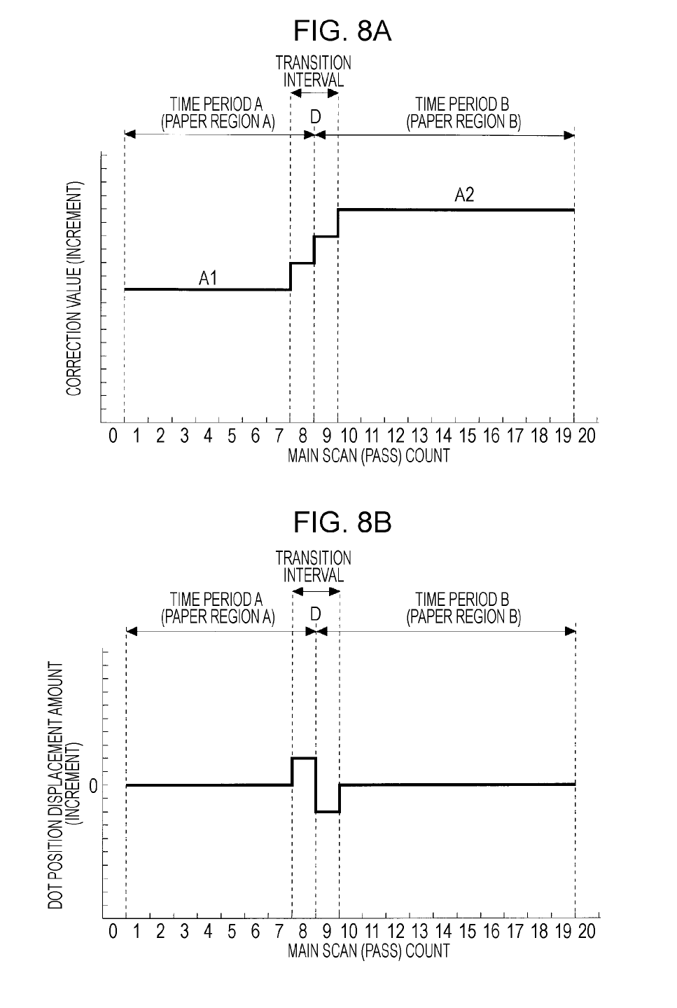

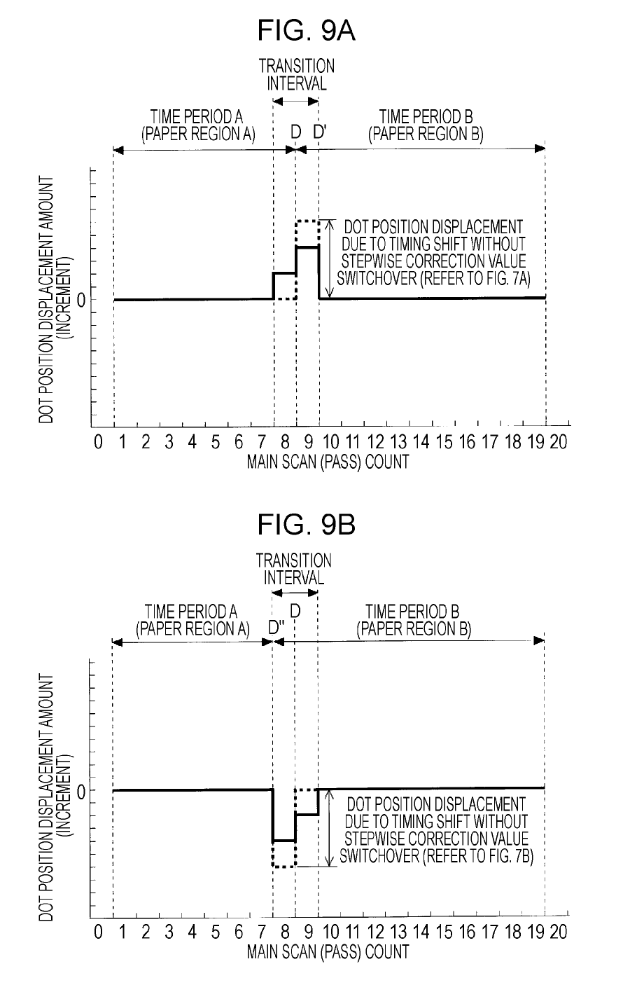

In order to provide a solution thereto, the control unit 50 allocates a transition interval that is used for making transitional switchover of the dot position displacement correction values. As illustrated in FIG. 8A, the transition interval starts from a certain point in time before the theoretical release timing D, which is recognized by the control unit 50 as a point in time at which the pair of paper transport rollers 4 is supposed to release the rear edge of the paper P, and ends at another point in time after the theoretical release timing D, which is, again, recognized by the control unit 50 as the point in time at which the pair of paper transport rollers 4 is supposed to release the rear edge of the paper P. The control unit 50 switches over the dot position displacement correction values from the correction value A1 to the correction value A2 in a graduated manner, that is, stepwise, during the transition interval. As a result of such a transitional switchover, as illustrated in a solid line in FIG. 9A, in a case where the actual point in time D′ at which the rear edge of the printing paper P is released from the pair of paper transport rollers 4 is shifted into a timing that is later than the theoretical release point in time D that is recognized by the control unit 50, it is possible to achieve a smaller dot position displacement amount in comparison with a case where correction values are not switched over in a graduated manner, which is shown in a dotted line in FIG. 9A.

On the other hand, as a result of such a transitional switchover, as illustrated in a solid line in FIG. 9B, in a case where the actual point in time D″ at which the rear edge of the printing paper P is released from the pair of paper transport rollers 4 is shifted into a timing that is earlier than the theoretical release point in time D that is recognized by the control unit 50, it is possible to achieve a smaller dot position displacement amount in comparison with a case where correction values are not switched over in a graduated manner, which is shown in a dotted line in FIG. 9B.

If the correction values are switched over stepwise as described above, minor dot position displacement occurs as illustrated in FIG. 8B even in a case where the actual point in time at which the rear edge of the printing paper P is released from the pair of paper transport rollers 4 coincides with the theoretical release point in time D that is recognized by the control unit 50. However, as illustrated in the drawing, the amount of dot position displacement that occurs in the case where the actual timing is in agreement with the theoretical timing is substantially small. If the actual point in time at which the rear edge of the printing paper P is released from the pair of paper transport rollers 4 is shifted from the theoretical release point in time D that is recognized by the control unit 50 under the condition that the correction values are not switched over in a graduated manner, which is shown in dotted lines in FIGS. 9A and 9B, substantially large dot position displacement occurs. In contrast thereto, the stepwise switchover of the correction values described above makes it possible to avoid such substantially large dot position displacement from occurring.

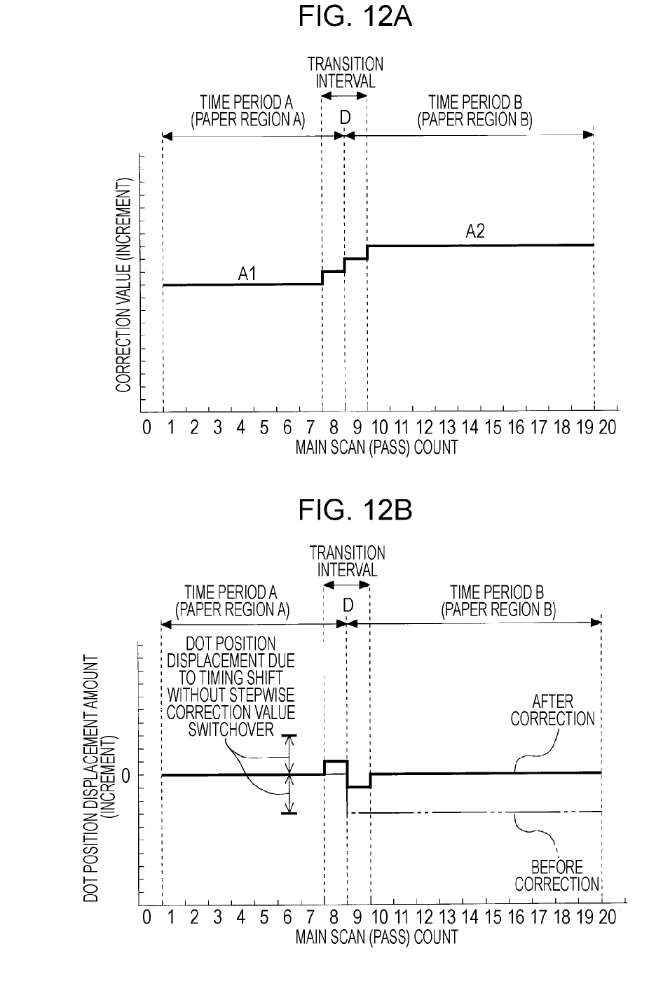

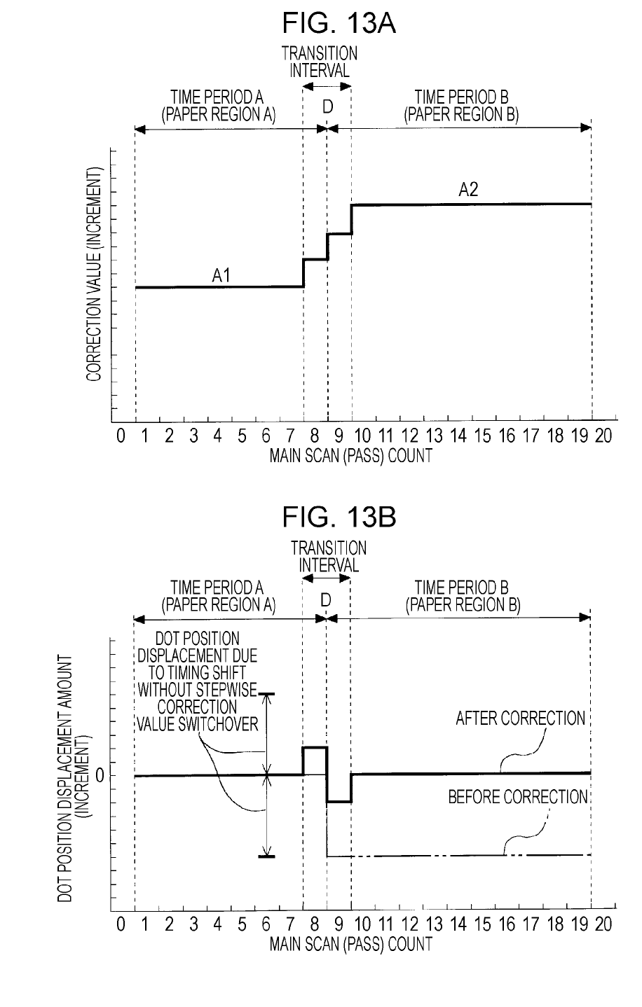

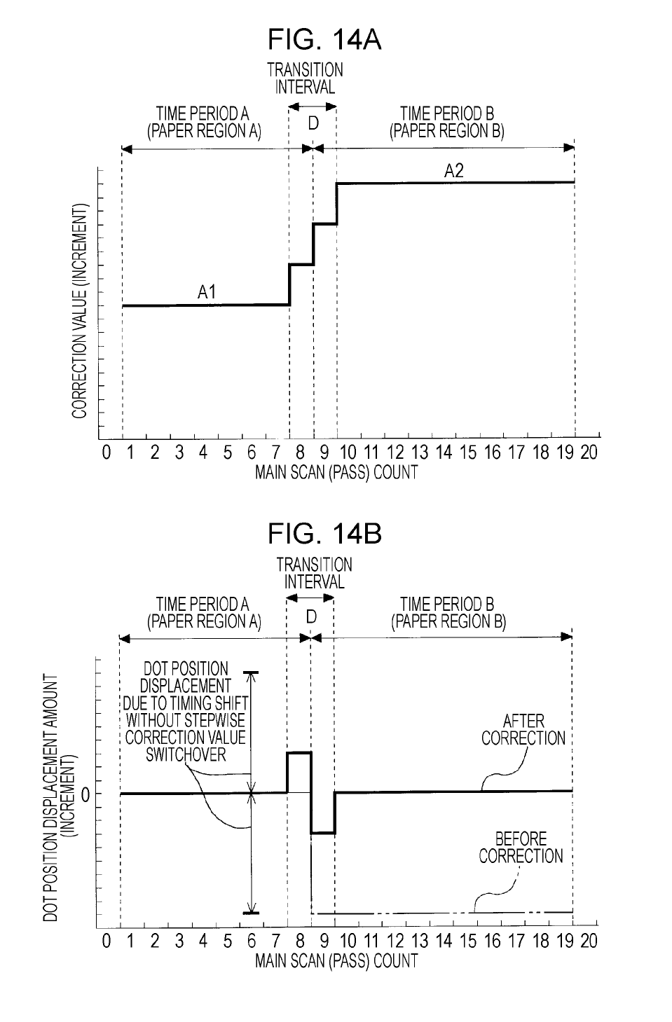

It should be noted that the stepwise switchover of the correction values described above is applied individually either for each of the plurality of nozzles or for each of the plurality of nozzle blocks. FIGS. 12, 13, and 14 is a set of diagrams that illustrates an exemplary case where the stepwise switchover of the correction values described above is applied to each of the plurality of nozzle blocks. Specifically, FIG. 12 shows the correction values (refer to FIG. 12A) and the dot position displacement amounts (refer to FIG. 12B) that are obtained as a result of the application of the correction values in a case where the stepwise switchover of the correction values described above is applied to the first nozzle block. FIG. 13 shows the correction values (refer to FIG. 13A) and the dot position displacement amounts (refer to FIG. 13B) that are obtained as a result of the application of the correction values in a case where the stepwise switchover of the correction values described above is applied to the second nozzle block. FIG. 14 shows the correction values (refer to FIG. 14A) and the dot position displacement amounts (refer to FIG. 14B) that are obtained as a result of the application of the correction values in a case where the stepwise switchover of the correction values described above is applied to the third nozzle block.

As illustrated in these drawings, since the correction value that is to be applied in the segment B differs from one nozzle block to another, the change amount of the correction values in the transition interval also differs from one nozzle block to another. As illustrated in each of FIGS. 12B, 13B, and 14B, a certain amount of dot position displacement occurs even in a case where there is not any timing shift between the actual timing and the theoretical timing. However, the amount of dot position displacement that occurs even when these timings coincide with each other is relatively small in comparison with a case where a timing shift occurs under the condition that the correction values are not switched over in a graduated manner. Therefore, the stepwise switchover of correction values that is applied to each of the plurality of nozzle blocks makes it possible to minimize the degradation in the quality of formed dots.

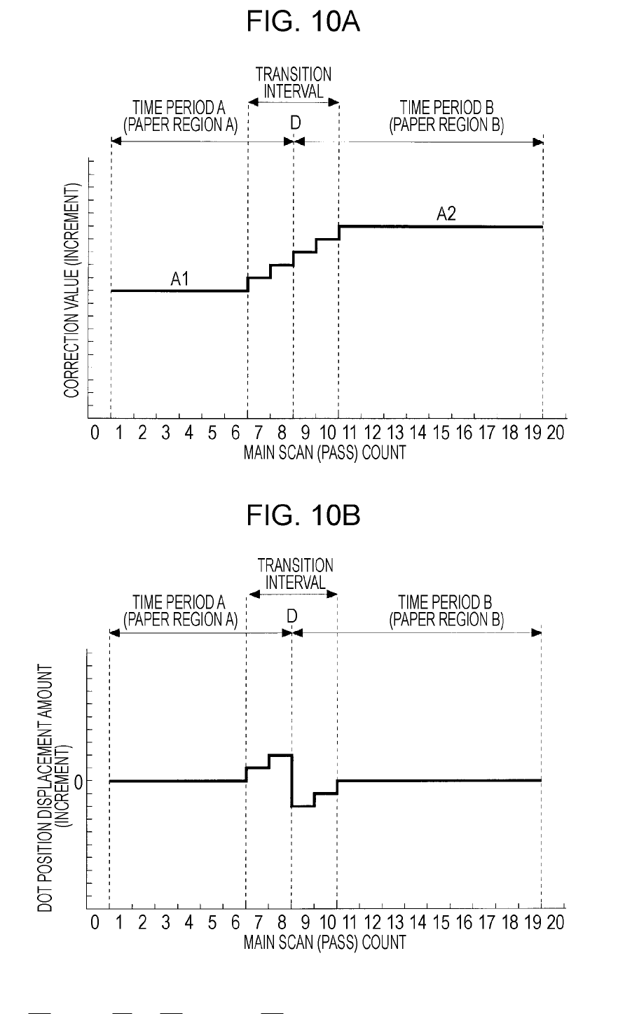

The length of the transition interval may be adjusted depending on the amount of the paper P that is to be transported in one execution of a printing job. For example, if the amount of the paper P that is to be transported in one execution of a printing job is small, and further if it is anticipated that the possible range of a shift between the actual point in time at which the rear edge of the printing paper P is released from the pair of paper transport rollers 4 and the theoretical release point in time D that is recognized by the control unit 5 is (relatively) wide, it is preferable to set a relatively long transition interval during which the correction values are switched over in a graduated manner as illustrated in FIG. 10A. By this means, it is possible to ensure that the actual point in time at which the rear edge of the printing paper P is released from the pair of paper transport rollers 4 falls within the transition interval. FIG. 10B shows the amount of displacement in dot positions that is obtained as a result of the application of correction values illustrated in FIG. 10A under an assumption that there is no timing shift between the actual point in time at which the rear edge of the printing paper P is released from the pair of paper transport rollers 4 and the theoretical release point in time D that is recognized by the control unit 5.

On the other hand, if the amount of the paper P that is to be transported in one execution of a printing job is large, even when the actual point in time at which the rear edge of the printing paper P is released from the pair of paper transport rollers 4 is shifted from the theoretical release point in time D that is recognized by the control unit 5 to some degree, there is relatively low possibility that the above-mentioned actual timing falls outside the duration of a certain paper transport operation (i.e., the n-th execution of the paper transport operation). Therefore, it is not necessary to set a long transition interval in such a case. Thus, in a case where the amount of the paper P that is to be transported in one execution of a printing job is large, it is preferable to set a short transition interval. By this means, it is possible to shorten the length of a time window in which the correction values deviate, though slightly, from original (i.e., proper, the same hereunder) ones, thereby further making it possible to prevent the occurrence of wasteful (i.e., avoidable) degradation in dot formation quality. If the length of the transition interval is adjusted depending on the amount of the paper P that is to be transported in one execution of a printing job, or in other words, depending on the recording scheme, it is possible to obtain a recording result with enhanced quality.

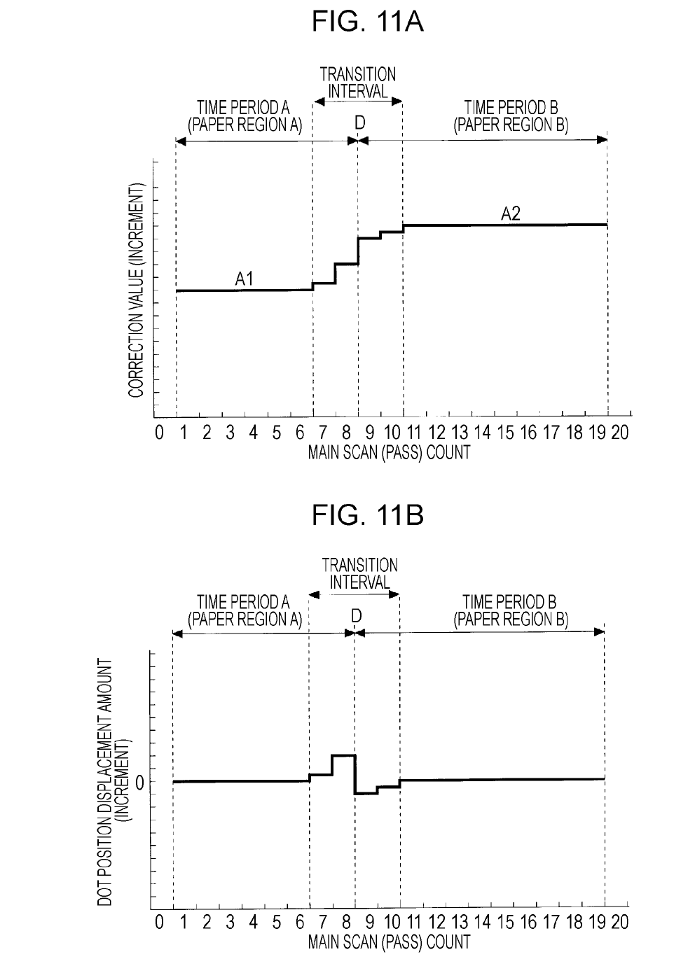

The amount of change in the correction values for one step during the transition interval may be adjusted depending on the position of the paper P in the sub-scan direction. For example, it may be adjusted depending on the position of the rear edge of the paper P in the sub-scan direction. Specifically, since the possibility that the rear edge of the printing paper P is actually released from the pair of paper transport rollers 4 is relatively low at the beginning and end of the transition interval, it is preferable to set the amount of change in the correction values relatively small as illustrated in FIG. 11A (refer to the seventh and tenth main scan operation), whereas the amount of change in the correction values is set to be relatively large at positions that are relatively close to the anticipated timing (D) at which the rear edge of the printing paper P is likely to be released from the pair of paper transport rollers 4 (refer to the eighth and ninth main scan operation). FIG. 11A is obtained as a modification result of the amount of change in correction values during the transition interval shown in FIG. 10A.

With such a configuration, it is possible to avoid any significant deviation of the correction values from original ones at the beginning period and end period of the transition interval during which the possibility that the rear edge of the printing paper P is actually released from the pair of paper transport rollers 4 is relatively low. By this means, it is possible to prevent any wasteful degradation in the quality of formed dots from occurring. FIG. 11B shows the amount of displacement in dot positions that is obtained as a result of the application of correction values that are varied depending on the position of the rear edge of the paper P (shown in FIG. 11A) under an assumption that there is no timing shift between the actual point in time at which the rear edge thereof is released from the pair of paper transport rollers 4 and the theoretical release point in time D that is recognized by the control unit 5. As one will understand from the comparison of FIGS. 10B and 11B, the setting of change amount shown in FIG. 11B makes it possible to further reduce the amount of displacement in dot positions.

The degree of paper elevation (i.e., raise) after the rear edge of the paper P has been released from the pair of paper transport rollers 4 could vary depending on the paper type, paper size, or ink color. Therefore, it is preferable to adjust absolute correction values that are to be applied in the segment A, the transition interval, and the segment B, respectively, depending on the paper type, paper size, or ink color. By this means, it is possible to obtain a recording result with further enhanced quality.

As the position of the paper P changes during sub scan, paper posture (e.g., degree of distortion thereof) could change accordingly. As the paper posture changes, the distance between the recording head 23 and the paper P could also change. In particular, after the rear edge of the paper P has been released from the pair of paper transport rollers 4, the distance between the recording head 23 and the paper P is susceptible to change at every moment of transport thereof. If the absolute correction values are adjusted depending on the sub-scan position of the paper P, it is possible to further improve dot formation quality.

In place of the dot-positional displacement correction values described above, the diameter of dots may be varied during the transition interval. After the rear edge of the paper P has been released from the pair of paper transport rollers 4, the precision in paper transport tends to decrease. For this reason, displacement in dot positions often occurs thereafter along the paper transport direction. If recording is performed with an increased diameter of dots after the rear edge of the paper P has been released from the pair of paper transport rollers 4, it is possible to make it more difficult to visually perceive the degradation in the quality of formed dots that is attributable to the decreased precision in the transport thereof.

Disadvantageously, however, if the actual point in time at which the rear edge of the printing paper P is released from the pair of paper transport rollers 4 is shifted into a timing that is earlier than the theoretical release point in time that is recognized by the control unit 50, recording is performed with the misapplication of smaller dots in the segment B whereas larger dots should be applied thereto. As a result of such misapplication, the degradation in dot formation quality will occur. On the other hand, if the actual point in time at which the rear edge of the printing paper P is released from the pair of paper transport rollers 4 is shifted into a timing that is later than the theoretical release point in time that is recognized by the control unit 50, recording is performed with the misapplication of larger dots in the segment A whereas smaller dots should be applied thereto. As a result of such misapplication, the degradation in dot formation quality will occur, which should be avoided.

In order to provide a solution thereto, as illustrated in FIG. 15A, the size of dots are switched over in a graduated manner during the transition interval. Specifically, the “correction value” shown on the vertical axis of FIG. 8A is replaced by the “dot diameter” in order to effect such a stepwise switchover. With such a configuration, even in a case where the actual point in time at which the rear edge of the printing paper P is released from the pair of paper transport rollers 4 is shifted from the theoretical release point in time D that is recognized by the control unit 50, it is possible to avoid, for example, the formation of smaller dots in the segment B so as to make it desirably difficult to visually perceive dot position displacement therein, which enhances recording quality. In addition, since the diameters of dots are varied stepwise, the configuration described above offers an additional advantageous effect in that it is relatively difficult to visually perceive the switchover of the dot diameters.

In such a modification example, if the amount of change in the dot sizes during the transition interval is set to be relatively large at positions that are relatively close to the anticipated timing (D) at which the rear edge of the printing paper P is likely to be released from the pair of paper transport rollers 4, that is, if the amount of change in the dot sizes during the transition interval is adjusted depending on the position of the rear edge of the paper P, it is possible to avoid any significant deviation of the dot sizes from original ones at the beginning period and end period of the transition interval during which the possibility that the rear edge of the printing paper P is actually released from the pair of paper transport rollers 4 is relatively low. By this means, it is possible to prevent any wasteful degradation in the quality of formed dots from occurring. Specifically, this is achieved if the “correction value” shown on the vertical axis of FIG. 11A is replaced by the “dot diameter”.

In the example illustrated in FIG. 15A, the sizes of dots aligned along the main scan direction are made uniform while varying stepwise in a uniform manner among them. Such a configuration may be modified, as shown in FIG. 15B, so that relatively small dots and relatively large dots are arrayed in a “mixed” pattern during the transition interval. That is, in such a modification example, as illustrated in FIG. 15B, the mixture ratio of dot sizes are switched over from the beginning to the end of the transition interval. Specifically, this is achieved if the “correction value” shown on the vertical axis of FIG. 6B is replaced by the “mixture ratio of relatively large dots”. With such a configuration, even in a case where the actual point in time at which the rear edge of the printing paper P is released from the pair of paper transport rollers 4 is shifted from the theoretical release point in time D that is recognized by the control unit 50, it is possible to avoid, for example, the formation of larger dots in the segment A beyond necessity. Thus, it is possible to minimize the degradation in dot formation quality.

As in the foregoing modification example, if the mixture ratio of relatively large dots during the transition interval is set to be relatively high at positions that are relatively close to the anticipated timing (D) at which the rear edge of the printing paper P is likely to be released from the pair of paper transport rollers 4, that is, if the mixture ratio of relatively large dot during the transition interval is adjusted depending on the position of the rear edge of the paper P, it is possible, also in this modification example, to avoid any significant deviation of the dot sizes from original ones at the beginning period and end period of the transition interval during which the possibility that the rear edge of the printing paper P is actually released from the pair of paper transport rollers 4 is relatively low. By this means, it is possible to prevent any wasteful degradation in the quality of formed dots from occurring. Specifically, this is achieved if the “correction value” shown on the vertical axis of FIG. 11A is replaced by the “mixture ratio of relatively large dots”.

The length of the transition interval may be adjusted depending on the amount of the paper P that is to be transported in one execution of a printing job in each of the examples explained above while referring to FIGS. 15A and 15B. For example, the length of the transition interval may be set relatively short if the amount of the paper P that is to be transported in one execution of a printing job is relatively large in the above examples shown in FIGS. 15A and 15B. By this means, it is possible to shorten the length of a time window in which the dot sizes deviate, though slightly, from original ones, thereby further making it possible to prevent the occurrence of wasteful degradation in dot formation quality.

As has already been explained earlier, the degree of paper elevation after the rear edge of the paper P has been released from the pair of paper transport rollers 4 could vary depending on the paper type, paper size, or ink color. Therefore, it is preferable to adjust dot sizes (absolute sizes thereof) that are to be applied in the segment A, the transition interval, and the segment B, respectively, depending on the paper type, paper size, or ink color. By this means, it is possible to obtain a recording result with further enhanced quality.

In the foregoing description, a technique for effectively avoiding any substantial degradation in dot formation quality that is caused when the rear edge of the paper P becomes released from the pair of paper transport rollers 4 is disclosed as an embodiment of the invention. Needless to say, this aspect of the invention is also applicable to the prevention of any substantial degradation in dot formation quality that is caused when the front edge of the paper P becomes nipped by the pair of paper ejection rollers 5.

In the exemplary embodiment of the invention described above, the stepwise switchover of the correction values is applied individually either for each of the plurality of nozzles or for each of the plurality of nozzle blocks. In other words, each of the plurality of nozzles or nozzle blocks has a unique dot position displacement correction value. However, the invention is in no case limited to such a configuration. For example, the same single dot-positional displacement correction value may be applied to all nozzles of the recording head 23 without setting a unique dot position displacement correction value for each of the plurality of nozzles or nozzle blocks. Even in such a configuration, needless to say, it is still possible to produce the advantageous effects of the invention described above if the correction values are switched over during a transition interval allocated for the transitional switchover of the dot position displacement correction value.

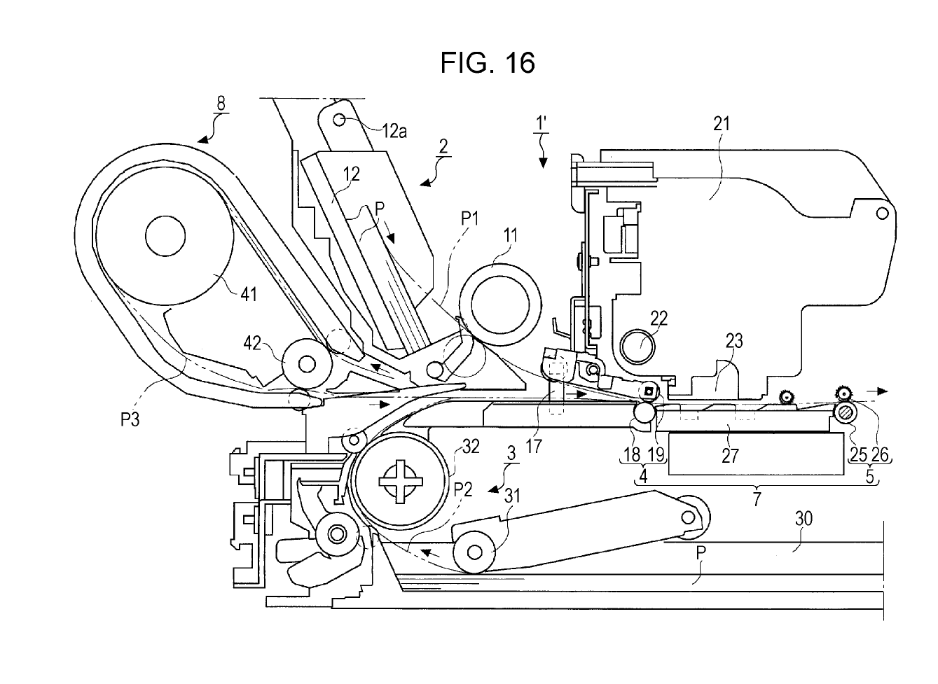

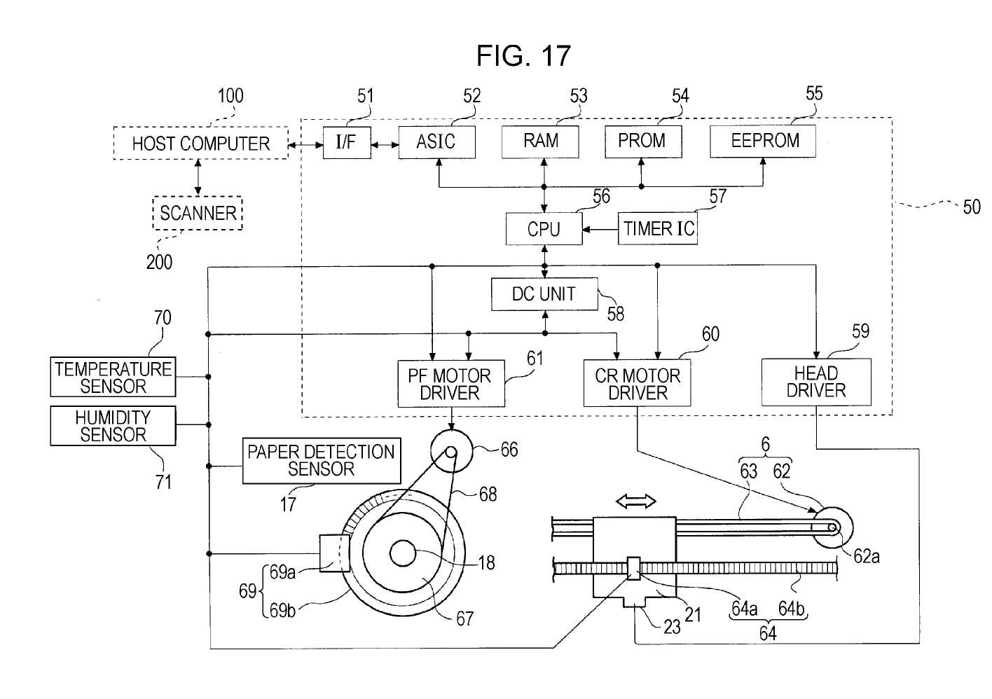

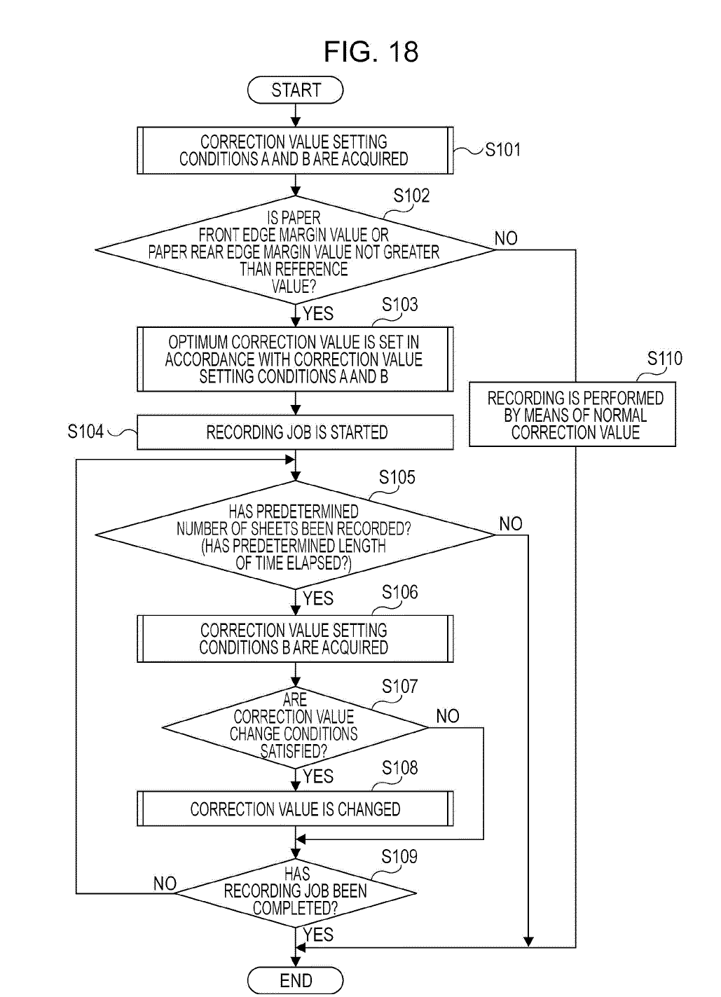

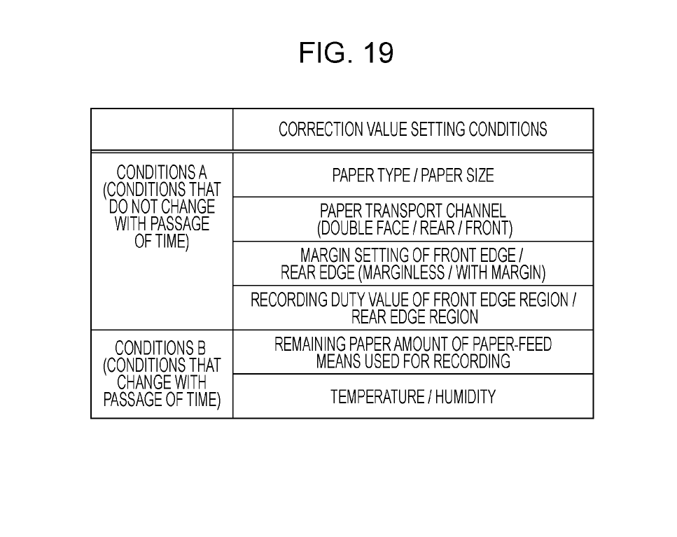

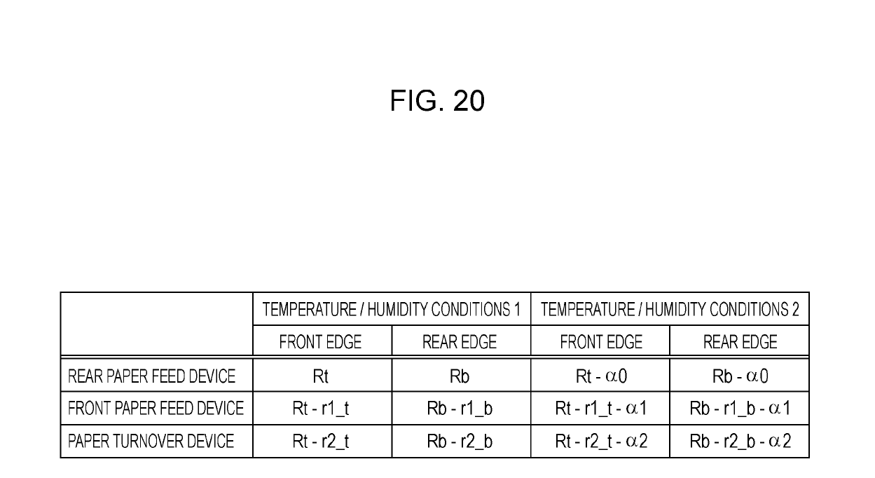

Next, with reference to FIGS. 16-20, another exemplary embodiment of the invention is described below. FIG. 16 is a side sectional view that schematically illustrates an example of the configuration of a printer according to another exemplary embodiment of the invention. FIG. 17 is a block diagram that illustrates an exemplary configuration of a control unit of the printer according to the above-mentioned another exemplary embodiment of the invention. FIG. 18 is a flowchart that illustrates an example of the procedures for setting dot position displacement correction values. FIG. 19 is a table that shows an example of the conditions for setting the dot position displacement correction values. FIG. 20 is a table that shows an example of correction values that are set on the basis of a paper transport channel, temperature/humidity conditions, and paper front/rear edge. In the explanation given below while referring to FIGS. 16-20, it should be noted that the same reference numerals are assigned to the same components as those of the printer 1 according to the foregoing exemplary embodiments of the invention; and a detailed explanation thereof is omitted, or an explanation is simplified as long as the understanding of the unique feature of the invention is not impaired.

As illustrated in FIG. 16, the printer 1′ according to the present embodiment of the invention is provided with the rear paper-feed device 2 at the rear portion thereof. In addition, the printer 1′ according to the present embodiment of the invention is further provided with a front paper-feed device 3 at the bottom portion thereof. These two paper-feed devices feed a sheet of paper P to the pair of paper transport rollers 4. A paper turnover device 8 is provided at the back of the rear paper-feed device 2. The paper turnover device 8 turns the incoming paper P over so that recording can be made on a second face of the paper P that is opposite a first face thereof on which recording has already been made. Thanks to the paper turnover device 8, the printer 1′ according to the present embodiment of the invention is capable of performing double-face printing.

In the following description, the operation and configuration of the printer 1′ is explained in further detail. The rear paper-feed device 2 has, as constituent members of the printer 1′ that are provided on the paper transport channel thereof, a hopper 12 and the paper-feed roller 11. The hopper 12 functions as a paper-set (tray) unit on which a plurality of sheets of paper P can be stacked. The hopper 12 can operate in a swinging direction around a swinging fulcrum 12a, which is provided at the upper portion thereof. As the hopper 12 operates in a swinging manner, the posture of the paper P that is placed on the hopper 12 is switched over between a raised state where the paper P is pressed against the paper-feed roller 11 and a lowered state where the paper P is distanced away from the paper-feed roller 11.

The front paper-feed device 3, which is provided at the bottom portion of the printer 1, allows a user to set the paper P from a frontal space viewed from the printer 1. The front paper-feed device 3 is provided with a paper-feed cassette 30, a pickup roller 31, and a paper-feed roller 32. The pickup roller 31 turns in contact with the uppermost sheet of the paper P that is stacked on the paper-feed cassette 30, which can be attached, from a frontal space viewed from the printer 1, to the printer 1 and detached therefrom. By this means, the uppermost sheet of the paper P is picked up from the paper-feed cassette 30. The paper-feed roller 32 turns over the uppermost sheet of the paper P, which has been fed thereto from the paper-feed cassette 30, in a curved (i.e., temporarily curled) manner so as to transport the reversed paper P to the pair of paper transport rollers 4.

The printer 1′ has a double-face recording mode. When performing double-face printing, after completion of recording on the first face of the paper P, the paper P is drawn back toward the upstream side and into the paper turnover device 8 without being ejected out of the printer 1′. The paper turnover device 8 has a feeding roller 42 and a turnover roller 41. The turnover roller 41 constitutes a paper turnover channel through which the incoming paper P is reversed in a curved manner. Specifically, the feeding roller 42 transports the incoming paper P to the turnover roller 41. The turnover roller 41 reverses the paper P so that the second face thereof, which is the reverse side of the first face thereof on which recording has already been done, faces toward the recording head 23. Then, as done at the time of the preceding recording on the first face thereof, the pair of paper ejection rollers 5, which functions now as a paper transport means, sub-scans the paper P toward the downstream side. Recording on the second face thereof is carried out during the sub-scan transport of the paper P.

As illustrated in FIG. 17, the printer 1′ has a temperature sensor 70 and a humidity sensor 71. The temperature sensor 70 detects temperature around the paper-guide front member 27, which is the ambient temperature of the paper P at a position opposite the recording head 23. The humidity sensor 71 detects humidity around the paper-guide front member 27. Temperature information of the temperature sensor 70 and humidity information of the humidity sensor 71 are inputted into the control unit 50.

In the configuration of the printer 1′ described above, the control unit 50 sets the dot position displacement correction value individually either for each of the plurality of nozzles or for each of the plurality of nozzle blocks as explained below.

Before starting recording operation, the control unit 50 acquires correction value setting conditions A and B as illustrated in FIG. 18 (step S101). The correction value setting conditions A and B can be determined on the basis of, for example, user configuration information such as a paper type, recording quality, and the like, each of which is set by a user, and further on the basis of detection information that is supplied from various kinds of sensors of the printer 1, which is known to a printer driver that operates on a host computer 100. As illustrated in FIG. 19, the correction value setting conditions A are made up of factors that do not change with the passage of time, whereas the correction value setting conditions B are made up of factors that change with the passage of time.

Specifically, as non-limiting constituent factors thereof according to the present embodiment of the invention, the correction value setting conditions A are made up of “paper type/paper size”, “paper transport channel condition (double face/rear/front)”, “front edge/rear edge of the paper P”, “margin setting of front edge/rear edge of the paper P (without margin/with margin)”, and “recording duty value of front-edge region/rear-edge region of the paper P”. On the other hand, as non-limiting constituent factors thereof according to the present embodiment of the invention, the correction value setting conditions B are made up of “remaining paper amount of a paper-feed means used for recording” and “temperature/humidity”. The dot-positional displacement correction values are set on the basis of these conditional factors.

The “double face” of the “paper transport channel condition (double face/rear/front)” is a printing condition that means whether double-face printing is to be performed or not, or in other words, whether the paper P should go through the paper turnover device 8 or not. The “rear/front” of the “paper transport channel condition” indicates which one of the paper-feed devices of the printer 1′, that is, either the rear paper-feed device 2 or the front paper-feed device 3, should be used for feeding the paper P. This printing factor is provided because the degree of a paper curl differs depending on which one of the paper transport channels the paper P travels through.

Specifically, as understood from FIG. 16, a sheet of paper that is fed from the rear paper-feed device 2, which is denoted as P1, another sheet of paper that is fed from the front paper-feed device 3, which is denoted as P2, and still another sheet of paper that goes through the paper turnover device 8, which is denoted as P3, are applied respective curling forces (i.e., curled postures) that differ from one to another. As a result thereof, the degree of paper elevation viewed from the paper-guide front member 27, the curl direction thereof, and the like differ from one to another as shown in FIG. 721. Therefore, it is preferable to set correction values while taking such differences into consideration. In like manner, since the degree of paper elevation varies depending on the “paper type/paper size”, correction values are set in accordance with the type and size of the paper P.

The marginless recording is not performed when a wide paper margin is set. Under such a setting condition, the paper P does not come away from the paper-guide front member 27, meaning that partial paper elevation does not occur. Therefore, correction values are set in accordance with the “margin setting of front edge/rear edge of the paper P (without margin/with margin)”.

The “recording duty value of front-edge region/rear-edge region of the paper P” is information on the amount of ink that is to be discharged on the front-edge region of the paper P and on the rear-edge region thereof. The paper P is less susceptible to an undesirable raise when the amount of ink discharged thereon is relatively large. Therefore, correction values are set in accordance with the “recording duty value of front-edge region/rear-edge region of the paper P”. The recording duty value varies depending on the recording data itself. In addition thereto, the recording duty value varies depending also on setting conditions such as a recording mode (e.g., high-definition printing mode, high-speed printing mode, and the like), the availability of an automatic picture quality enhancement function (i.e., automatic data processing performed by a printer driver for the improvement of recording picture quality), though not limited thereto.

The “remaining paper amount of a paper-feed means used for recording” means the thickness of paper stacked at each paper-feed device. The curled posture of the paper differs depending on the thickness of a stack of paper at the time of feeding thereof, which results in a difference in the degree of paper elevation. Therefore, correction values are set in accordance with the “remaining paper amount of a paper-feed means used for recording”. It should be noted that it is possible to obtain information on the remaining amount of the paper, that is, the thickness of a stack of the paper, by means of a device that measures the thickness of the stack of the paper that is placed on each paper-feed device.

The degree of paper elevation is relatively small in, for example, a high temperature and humidity environment. Therefore, correction values are set in accordance with the “temperature/humidity”.

If there is any additional or substitute factor that has an effect on the degree of paper elevation with respect to the paper-guide front member 27, that is, how much the paper P comes away from the paper-guide front member 27, other than those described above, needless to say, dot-positional displacement correction values may also be set on the basis of such a factor. For example, if the flight characteristics of ink drops differ depending on ink color, correction values may be set on the basis of the ink color, or in other words, ink type.

If the paper P is curled in the main-scan direction, the degree of paper elevation at the end regions thereof differs from that of the center region thereof. Therefore, dot-positional displacement correction values may be adjusted in accordance with the position of the recording head 23 along the main-scan direction. By this means, it is possible to further improve dot formation quality.

In some cases, the degree of a paper curl that is formed when the paper P goes through the paper turnover channel could be mitigated as time elapses thereafter. Therefore, correction values may be adjusted on the basis of the length of time from the passage of the paper P (the front-edge region or the rear-edge region thereof) through the paper turnover channel till the execution of a recording job.

Referring back to the flowchart of FIG. 18, as a step subsequent to the aforementioned step S101, a judgment is made as to whether the margin value for the front edge of the paper P or the rear edge thereof is not greater than a reference value or not, that is, whether marginless recording is to be performed or not (step S102). If the margin value for the front edge of the paper P is greater than the reference value (step S102: NO), which means that marginless recording is not performed, there occurs no paper elevation that is explained while referring to FIG. 721 during the execution of a recording job, or in other words, recording is performed while the front edge of the paper P or the rear edge thereof is nipped constantly. Therefore, in such a case, recording is performed by means of proper correction values that have been determined in advance on the basis of minimum conditions such as a paper type and the like (i.e., predetermined normal correction values) (step S110).

On the other hand, if the result of a decision made at the step S102 is YES, optimum correction values are set on the basis of the conditions described above (step S103). Then, a recording job is initiated (step S104). After the start of the recording job, a judgment is made as to whether conditions that change with the passage of time, that is, the correction value setting conditions B, should be re-acquired or not in a judgment step S105, which is repeated in a loop-back manner until the completion of the recording job (step S109). If it is judged that the conditions that change with the passage of time should be re-acquired (step S105: YES), the correction value setting conditions B are acquired (step S106). If it is judged that correction value change conditions are satisfied as a result thereof (step S107: YES), the correction values are changed (step S108).

In the present embodiment of the invention, the above-mentioned judgment as to whether the conditions that change with the passage of time, that is, the correction value setting conditions B, should be re-acquired or not (step S105) is made on the basis of a result of checking whether a predetermined number of sheets of the paper P, for example, two sheets thereof, has already been recorded or not, and/or a result of checking whether a predetermined time period, for example, three minutes, has already elapsed or not. The result of the former check is used as the basis of the judgment made at the step S105 because there is a possibility that, as the remaining paper amount of a paper-feed means (i.e., the thickness of the paper stack thereat) changes after the recording of the predetermined number of sheets (or greater) of the paper P, the curled posture thereof might change. The result of the latter check is used as the basis of the judgment made at the step S105 because there is a possibility that the degree of paper elevation might change due to a change in temperature and/or humidity as the predetermined length of time (or longer) elapses.

Next, in a step S107, it is checked whether a change in the thickness of the stack of the paper that is set at the paper-feed means has exceeded a predetermined amount and whether a change in temperature/humidity has exceeded a predetermined amount. On the basis of check results thereof, it is judged in this step S107 whether the correction values should be changed or not.

As explained above, the dot-positional displacement correction values are initially set on the basis of the correction value setting conditions A and B that are acquired at the time of the starting of a recording job (step S103). After the start of the recording job, the conditions that change with the passage of time, that is, the correction value setting conditions B, are re-acquired when it becomes necessary (step S106). Then, if it is judged that a certain change in a condition that requires the correction values to be changed has occurred, the correction values are reset (step S108).

The dot position displacement correction value is individually set for each of the following segments: a segment up to a point where the front edge of the paper P becomes nipped by the pair of paper ejection rollers 5, a segment in which the paper P is nipped by both of the pair of paper transport rollers 4 and the pair of paper ejection rollers 5, and a segment after a point where the paper P is released from the pair of paper transport rollers 4. The method for setting the dot position displacement correction value that is explained above while referring to FIGS. 18 and 19 is applied to a segment up to a point where the front edge of the paper P becomes nipped by the pair of paper ejection rollers 5 and a segment after a point where the paper P is released from the pair of paper transport rollers 4 (for determination of the dot position displacement correction value).

In some case, the degree of paper elevation during a segment up to a point where the front edge of the paper P becomes nipped by the pair of paper ejection rollers 5 could be different from the degree of paper elevation during a segment after a point where the paper P is released from the pair of paper transport rollers 4. In such a case, a correction value is individually set for the segment up to a point where the front edge of the paper P becomes nipped by the pair of paper ejection rollers 5 and for the segment after a point where the paper P is released from the pair of paper transport rollers 4 while taking such a difference in the degree of paper elevation into consideration.

FIG. 20 is a table that shows an example of dot position displacement correction values that are set on the basis of factors including a paper transport channel, temperature/humidity conditions, and front/rear edge. As shown in this table, when the paper P is fed from the rear paper-feed device 2 under temperature/humidity conditions 1, the correction value Rt is used for recording on the front edge of the paper P whereas the correction value Rb is used for recording on the rear edge thereof.

If temperature/humidity conditions 2 are higher (in temperature and humidity) than the temperature/humidity conditions 1, the degree of paper elevation is mitigated, that is, smaller, under such conditions (temperature/humidity conditions 2). Therefore, when the paper P is fed from the rear paper-feed device 2 under the temperature/humidity conditions 2, the adjusted correction value “Rt−α0” is used for recording on the front edge of the paper P, where “α0” denotes an adjustment value that is subtracted from the pre-adjustment correction value Rt, whereas the adjusted correction value “Rb−α0” is used for recording on the rear edge thereof, where “α0” denotes an adjustment value that is subtracted from the pre-adjustment correction value Rb. As another adjustment value that is applied to a case where the paper P is fed from the front paper-feed device 3, “α1” is subtracted therefrom. As still another adjustment value that is applied to a case where the paper P goes through the paper turnover device 8, “α2” is subtracted therefrom.

When the paper P is fed from the front paper-feed device 3 under the temperature/humidity conditions 1, the direction of a curl formed thereon is opposite to that is formed when the paper P is fed from the rear paper-feed device 2 under the same temperature/humidity conditions, which results in a smaller degree of paper elevation. Therefore, the adjusted correction value “Rt−r1_t” is used for recording on the front edge of the paper P, where “r1_t” denotes an adjustment value that is subtracted from the pre-adjustment correction value Rt, whereas the adjusted correction value “Rb−r1_b” is used for recording on the rear edge thereof, where “r1_b” denotes an adjustment value that is subtracted from the pre-adjustment correction value Rb.

In like manner, when the paper P goes through the paper turnover device 8, the adjusted correction value “Rt−r2_t” is used for recording on the front edge of the paper P, where “r2_t” denotes an adjustment value that is subtracted from the pre-adjustment correction value Rt, whereas the adjusted correction value “Rb−r2_b” is used for recording on the rear edge thereof, where “r2_b” denotes an adjustment value that is subtracted from the pre-adjustment correction value Rb.

It is possible to determine the correction values described above by pre-measuring the degree of paper elevation under each recording conditions for each of plural types of paper that are expected to be used, that is, the paper types recorded in a printer driver. There are some factors for which it is difficult to experimentally measure the degree of paper elevation in advance for all recording conditions. A few non-limiting examples thereof are the recording duty value and environmental conditions (e.g., temperature and humidity, though not limited thereto). As for these factors, a correction value or an adjustment value may be calculated on the basis of a mathematical formula that is obtained as a result of an experiment conducted under a plurality of conditions. For example, regarding the recording-duty-value factor, an experiment is conducted under a plurality of conditions so as to obtain, on the basis of the result of the experiment, a mathematical formula that defines a mathematical relationship between the recording duty value and the degree of paper elevation. Then, a correction value or an adjustment value can be calculated on the basis of the obtained mathematical formula.

What is claimed is:

1. A liquid ejecting apparatus comprising:
a liquid ejecting head that has liquid ejecting nozzles, the liquid ejecting nozzles forming dots on an ejection target medium by ejecting liquid onto the ejection target medium;
a main scan section that scans the liquid ejecting head in a main scan direction;
a sub scan section that scans the ejection target medium in a sub scan direction, the sub scan section including a pair of transport rollers and a pair of ejection rollers, the pair of transport rollers being provided at an upstream position with respect to the liquid ejecting head, the pair of ejection rollers being provided at a downstream position with respect to the liquid ejecting head;
a detecting section that detects the position of the ejection target medium on a transport channel; and
a controlling section that acquires, on the basis of information supplied from the detecting section, an expected timing of a switchover between a state in which the ejection target medium is nipped by both of the pair of transport rollers and the pair of ejection rollers and a state in which the ejection target medium is nipped by only one of the pair of transport rollers and the pair of ejection rollers, and that changes, during a plurality of main scan operations in a transition interval that is set around the expected timing, either the positions of the dots or the sizes of the dots with respect to the main scan direction stepwise.

2. The liquid ejecting apparatus according to claim 1, wherein the controlling section changes either the positions of the dots or the sizes of the dots with respect to the main scan direction during the plurality of main scan operations with an unequal difference.

3. The liquid ejecting apparatus according to claim 1, wherein the controlling section changes either the positions of the dots or the sizes of the dots with respect to the main scan direction during a first main scan operation within the transition interval by a first change amount, whereas the controlling section changes either the positions of the dots or the sizes of the dots with respect to the main scan direction during a second main scan operation, which is closer to the expected timing than the first main scan operation, within the transition interval by a second change amount, which is greater than the first change amount.

4. The liquid ejecting apparatus according to claim 1, wherein the controlling section adjusts the length of the transition interval depending on the amount of one transport of the ejection target medium when the ejection target medium is transported in an intermittent manner.

5. The liquid ejecting apparatus according to claim 1, wherein the controlling section adjusts the amount of a change during the plurality of main scan operations depending on a type of the ejection target medium.

6. The liquid ejecting apparatus according to claim 1, wherein the controlling section adjusts the amount of a change during the plurality of main scan operations depending on a size of the ejection target medium.

7. The liquid ejecting apparatus according to claim 1, wherein the controlling section adjusts the amount of a change during the plurality of main scan operations depending on a type of liquid that is ejected onto the ejection target medium.

8. The liquid ejecting apparatus according to claim 1, further comprising a plurality of ejection target medium transport channels for transporting the ejection target medium to the pair of transport rollers, wherein the controlling section adjusts the amount of a change during the plurality of main scan operations depending on the ejection target medium transport channel.

9. The liquid ejecting apparatus according to claim 1, wherein the controlling section adjusts the amount of a change during the plurality of main scan operations depending on an amount of liquid that is ejected onto the ejection target medium.

10. The liquid ejecting apparatus according to claim 1, wherein the controlling section adjusts the amount of a change during the plurality of main scan operations depending on environmental conditions of the ejection target medium.

11. The liquid ejecting apparatus according to claim 1, wherein the controlling section changes either the positions of the dots or the sizes of the dots with respect to the main scan direction for each of the liquid ejecting nozzles or each of a plurality of nozzle blocks that is made up of the liquid ejecting nozzles.
